(19) United States
(12) Patent Application Publication
(10) Pub. No.: US 2013/0314796 A1
(43) Pub. Date: Nov. 28, 2013

(54) LIGHT REFLECTION PLATE

(71) Applicants: Kazutoshi Hitomi, Tenri-shi (JP); Kengo Suzuki, Tenri-shi (JP)

(72) Inventors: Kazutoshi Hitomi, Tenri-shi (JP); Kengo Suzuki, Tenri-shi (JP)

(21) Appl. No.: 13/983,764

(22) PCT Filed: Feb. 10, 2012
(86) PCT No.: PCT/JP2012/053045

§ 371 Date: Aug. 5, 2013

(30) Foreign Application Priority Data
Feb. 21, 2011 (JP) 2011-035076

(51) Int. Cl. G02B 5/02

(52) U.S. Cl. CPC G02B 5/0226
USPC 359/599

(57) ABSTRACT

There is provided a light reflection plate that can uniformly exhibit high light diffusibility. The light reflection plate includes 100 parts by weight of a polyolefin-based resin and 20 to 120 parts by weight of a coated titanium oxide that is obtained by coating a surface of titanium oxide with a coating layer containing aluminum oxide and silicon oxide. The coated titanium oxide is constituted by primary particles having a particle size of 0.10 to 0.39 μm and agglomerated particles which are formed by agglomeration of the primary particles and have a particle size of 0.4 μm or more. The number of the agglomerated particles in a cross section of the light reflection plate in a thickness direction is 0.1 to 4.5 /900 μm² and the number of the primary particles, which are not agglomerated, in the cross section of the light reflection plate in the thickness direction is 1.5 to 11.0 /900 μm².

### TECHNICAL FIELD

The present invention relates to a light reflection plate having high light reflection performance and light diffusibility.

### BACKGROUND ART

In recent years, liquid crystal display apparatuses have been used in various applications as display apparatuses. In such liquid crystal display apparatuses, a backlight unit is disposed on a back surface of a liquid crystal cell. The backlight unit includes a light source such as a cold-cathode tube or an LED, a lamp reflector, a light-guiding plate, and a light reflection plate disposed on the back surface side of the light-guiding plate. The light reflection plate reflects, toward the liquid crystal cell, light leaked from the back surface of the light-guiding plate.

The light reflection plate is, for example, a metal thin plate composed of aluminum or stainless steel, a film formed by depositing silver on a polyethylene terephthalate film, a metal foil prepared by laminating an aluminum foil, or a porous resin sheet.

A light reflection plate produced by incorporating an inorganic filler such as barium sulfate, calcium carbonate, or titanium oxide in a polypropylene-based resin is also used as a light reflection plate having high productivity.

PTL 1 discloses, as a light reflection plate, a reflection film containing a resin composition that contains an aliphatic polyester-based resin or a polyolefin-based resin and a fine powder filler, wherein a layer in which the content of the fine powder filler in the resin composition is more than 0.1% by mass and less than 5% by mass is used as an outermost layer on the reflection surface side.

In recent years, an increase in the luminance of display apparatuses and a further improvement in the uniformity of the luminance have been required. However, the above reflection film poses a problem in that the light reflection performance and the uniformity of light reflection in terms of light diffusion are not sufficiently achieved.

On the other hand, titanium oxide poses the following problem. When titanium oxide receives light, the titanium oxide is activated to generate a radical. Consequently, an organic material that is in contact with the titanium oxide undergoes oxidative decomposition and turns yellow, which decreases the light reflectance of the light reflection plate.

It is also known that, when titanium oxide is irradiated with ultraviolet light, a photochemical change occurs in a titanium oxide crystal and the number of oxygen defects increases, whereby purple-blue Ti³⁺ is generated and the titanium oxide turns dark gray. Since this photochemical change is a reversible change, the color of the titanium oxide gradually returns to white from dark gray when the titanium oxide is left in a dark place.

The titanium oxide used in the reflection film disclosed in PTL 1 is a titanium oxide that poses the above problem. Therefore, the reflection film poses a problem in that the light reflectance decreases with usage of the reflection film.

### CITATION LIST

### Patent Literature

PTL 1: Japanese Patent No. 4041160

### SUMMARY OF INVENTION

### Technical Problem

The present invention provides a light reflection plate in which high light reflection performance and light diffusibility can be stably maintained for a long time.

### Solution to Problem

The present invention provides a light reflection plate including 100 parts by weight of a polyolefin-based resin and 20 to 120 parts by weight of a coated titanium oxide obtained by coating a surface of titanium oxide with a coating layer containing aluminum oxide and silicon oxide,

wherein the coated titanium oxide is constituted by primary particles having a particle size of 0.10 to 0.39 μm and agglomerated particles which are formed by agglomeration of the primary particles and have a particle size of 0.4 μm or more,

the number of the primary particles, which are not agglomerated, in a cross section of the light reflection plate in a thickness direction is 150 to 550 /900 μm², and

the number of the agglomerated particles in the cross section of the light reflection plate in the thickness direction is 10 to 160 /900 μm².

In other words, the light reflection plate of the present invention includes:

100 parts by weight of a polyolefin-based resin; and

20 to 120 parts by weight of a coated titanium oxide obtained by coating a surface of titanium oxide with a coating layer containing aluminum oxide and silicon oxide, the coated titanium oxide being constituted by primary particles having a particle size of 0.10 to 0.39 μm and agglomerated particles which are formed by agglomeration of the primary particles and have a particle size of 0.4 μm or more,

wherein the number of the primary particles, which are not agglomerated, in a cross section in a thickness direction is 150 to 550 /900 μm², and

the number of the agglomerated particles in the cross section in the thickness direction is 10 to 160 /900 μm².

### Advantageous Effects of Invention

The light reflection plate of the present invention includes a particular amount of primary particles which have a particle size of 0.10 to 0.39 μm and are not agglomerated. Such primary particles having a small particle size provide high light reflection performance.

The light reflection plate of the present invention includes a particular amount of agglomerated particles which are formed by agglomeration of the primary particles and have a particle size of 0.4 μm or more. Since the agglomerated particles are formed by agglomeration of the primary particles, the surfaces of the agglomerated particles have larger irregularities than those of the primary particles and thus the agglomerated particles have higher light diffusibility than the primary particles. Therefore, the agglomerated particles contained in the light reflection plate in a particular amount can reflect light that enters the light reflection plate while diffusing the light. Accordingly, the light reflection plate has high light reflection performance and light diffusibility.

When the light diffusibility of the light reflection plate is not sufficiently high, it is considered that a light diffusion layer containing light diffusion particles is formed on the surface of the light reflection plate. However, since the light reflection plate of the present invention have high light diffusibility as described above, there is no need to form the light diffusion layer or the thickness of the light diffusion layer can be decreased. As a result, the lightweight property and production efficiency of the light reflection plate can be improved.

The coated titanium oxide contained in the light reflection plate of the present invention is obtained by coating a surface of titanium oxide with a coating layer containing aluminum oxide and silicon oxide. Therefore, the titanium oxide of the coated titanium oxide is not in direct contact with the polyolefin-based resin. In addition, the coating layer of the coated titanium oxide absorbs ultraviolet light and substantially prevents the ultraviolet light from entering the titanium oxide, thereby substantially suppressing photocatalysis of the titanium oxide. Thus, the polyolefin-based resin is not colored due to the oxidative decomposition caused by the titanium oxide, and high light reflection performance and light diffusibility of the light reflection plate are maintained for a long time.

In the coated titanium oxide, the coating layer substantially prevents ultraviolet light from entering the titanium oxide, which can prevent the discoloration to dark gray caused by oxygen defects generated as a result of the photochemical change in a titanium oxide crystal. Therefore, the light reflection plate hardly undergoes coloration resulting from the discoloration of titanium oxide during its use and the light reflection plate exhibits high light reflection performance during its use.

### BRIEF DESCRIPTION OF DRAWINGS

FIG. 1 is a schematic sectional view of a backlight unit of a liquid crystal display apparatus in which a light reflection plate of the present invention is suitably used.

FIG. 2 is a perspective view of a thermoformed light reflection plate of the present invention.

FIG. 3 is a longitudinal sectional view of the thermoformed light reflection plate of the present invention.

FIG. 4 is a longitudinal sectional view of an illuminating apparatus that uses the thermoformed light reflection plate of the present invention.

### DESCRIPTION OF EMBODIMENTS

A light reflection plate of the present invention includes 100 parts by weight of a polyolefin-based resin and 20 to 120 parts by weight of a coated titanium oxide obtained by coating a surface of titanium oxide with a coating layer containing aluminum oxide and silicon oxide. In this light reflection plate, the coated titanium oxide is dispersed in the polyolefin-based resin.

The coated titanium oxide included in the light reflection plate of the present invention is constituted by primary particles having a particle size of 0.10 to 0.39 μm and agglomerated particles that are formed by agglomeration of the primary particles and have a particle size of 0.4 μm or more. The agglomerated particles are formed by agglomeration of a plurality of primary particles of the coated titanium oxide.

If the particle size of the agglomerated particles of the coated titanium oxide is small, the irregularities on the surfaces of the agglomerated particles do not become sufficiently large, which degrades the light diffusibility exhibited by the agglomerated particles and thus degrades the light diffusibility of the light reflection plate. Therefore, the particle size of the agglomerated particles is limited to 0.4 μm or more. If the particle size of the agglomerated particles of the coated titanium oxide is excessively large, large projections may be partially formed on the surface of the light reflection plate. Such projections sometimes make the light diffusibility of the light reflection plate uneven. Therefore, the particle size of the agglomerated particles of the coated titanium oxide is preferably 0.4 to 1.3 μm and more preferably 0.4 to 1.2 μm.

The number of the agglomerated particles of the coated titanium oxide included in the light reflection plate is limited to 10 to 160 /900 μm² in a cross section of the light reflection plate in the thickness direction, but is preferably 20 to 150 /900 μm² and more preferably 30 to 140 /900 μm². If the number of the agglomerated particles is excessively small, the light reflection performance exhibited by the agglomerated particles is not sufficiently achieved, which may degrade the light diffusibility of the light reflection plate. If the number of the agglomerated particles is excessively large, the number of unagglomerated primary particles contained in the light reflection plate decreases. As a result, the light reflection performance of the light reflection plate degrades and large projections may be partially formed on the surface of the light reflection plate by the agglomerated particles. The formation of such projections sometimes makes the light diffusibility of the light reflection plate uneven.

The particle size of the primary particles of the coated titanium oxide included in the light reflection plate of the present invention is limited to 0.10 to 0.39 μm, but is preferably 0.14 to 0.39 μm. With a coated titanium oxide having such a primary particle size, high light reflection performance and light diffusibility can be imparted to the light reflection plate.

The light reflection plate of the present invention contains unagglomerated primary particles of the coated titanium oxide in addition to the above-described agglomerated particles. When unagglomerated primary particles of the coated titanium oxide having a primary particle size in the above range are finely dispersed in the light reflection plate, high light reflection performance can be imparted to the light reflection plate.

The number of the unagglomerated primary particles of the coated titanium oxide included in the light reflection plate is limited to 150 to 550 /900 μm² in a cross section of the light reflection plate in the thickness direction, but is preferably 180 to 500 /900 μm² and more preferably 200 to 500 /900 μm². If the number of the unagglomerated primary particles of the coated titanium oxide is excessively small, the light reflection performance of the light reflection plate may degrade. If the content of the unagglomerated primary particles of the coated titanium oxide is excessively high, an improvement in the light diffusibility corresponding to such a large number of unagglomerated primary particles is not achieved and also such a large amount of coated titanium oxide may degrade the lightweight property of the light reflection plate.

The particle size and number of particles of the coated titanium oxide included in the light reflection plate can be measured as follows. First, the light reflection plate is cut along its whole length in the thickness direction of the light reflection plate, that is, in a direction perpendicular to the surface of the light reflection plate. A micrograph of the cross section of the light reflection plate is then taken at a magnification of 2500 times or more using a scanning electron microscope (SEM), and a square measurement region with 30 μm sides in the cross section of the light reflection plate is selected from the SEM micrograph. Subsequently, the particles of the coated titanium oxide contained in this measurement region are observed at a magnification of 10,000 times or more using the SEM to determine unagglomerated primary particles and agglomerated particles formed by agglomeration of the primary particles. The particle size (μm) of the primary particles and the particle size (μm) of the agglomerated particles formed by agglomeration of the primary particles are then measured. Furthermore, the number (/900 μm²) of unagglomerated primary particles having a particle size of 0.10 to 0.39 μm and the number (/900 μm²) of agglomerated particles that are formed by the agglomeration of primary particles and have a particle size of 0.4 μm or more are measured.

In the present invention, the primary particle size of the coated titanium oxide refers to the diameter of a minimum perfect circle that can encompass a primary particle. The particle size of the agglomerated particles of the coated titanium oxide refers to the diameter of a minimum perfect circle that can encompass the agglomerated particle.

The above measurement is performed in at least ten measurement regions selected so as not to overlap each other in the cross section of the light reflection plate. The arithmetic mean of the numbers (/900 μm²) of unagglomerated primary particles having a particle size of 0.10 to 0.39 μm in the measurement regions is defined as the number (/900 μm²) of primary particles contained in the light reflection plate. The arithmetic mean of the numbers (/900 μm²) of agglomerated particles that are formed by agglomeration of the primary particles and have a particle size of 0.4 μm or more in the measurement regions is defined as the number (/900 μm²) of agglomerated particles contained in the light reflection plate.

The coated titanium oxide is obtained by coating a surface of titanium oxide (TiO₂) with a coating layer containing aluminum oxide and silicon oxide.

Titanium oxide is represented by chemical formula TiO₂. A rutile-type titanium oxide, an anatase-type titanium oxide, and an ilmenite-type titanium oxide are exemplified, and a rutile-type titanium oxide is preferably used because of its high weather resistance.

By coating the surface of titanium oxide with the coating layer containing aluminum oxide and silicon oxide, the direct contact between the titanium oxide and the polyolefin-based resin is prevented, which can suppress the degradation of the polyolefin-based resin due to the photocatalysis of the titanium oxide.

In the coated titanium oxide, the amount of the aluminum oxide quantitatively determined by X-ray fluorescence analysis in terms of Al₂O₃ is preferably 1% to 6% by weight, more preferably 1% to 5% by weight, and particularly preferably 1% to 4% by weight relative to the total weight of titanium dioxide in the coated titanium oxide.

In other words, in the coated titanium oxide, the amount of the aluminum oxide quantitatively determined by X-ray fluorescence analysis in terms of Al₂O₃ is preferably 1% to 6% by weight, more preferably 1% to 5% by weight, and particularly preferably 1% to 4% by weight, assuming that the total weight of titanium dioxide in the coated titanium oxide is 100% by weight.

If the amount of the aluminum oxide in the coating layer of the coated titanium oxide is excessively small, the photocatalysis of the titanium oxide is not sufficiently suppressed, which causes coloration of the polyolefin-based resin resulting from the degradation of the polyolefin-based resin. Consequently, the light reflection performance of the light reflection plate may degrade. If the amount of the aluminum oxide in the coating layer of the coated titanium oxide is excessively large, the coating layer absorbs visible light, which degrades the light reflection caused by the titanium oxide. Consequently, the light reflection performance of the light reflection plate may degrade.

In the coated titanium oxide, the amount of the silicon oxide quantitatively determined by X-ray fluorescence analysis in terms of SiO₂ is preferably 0.1% to 7% by weight, more preferably 0.1% to 6% by weight, and particularly preferably 0.1% to 5% by weight relative to the total weight of titanium dioxide in the coated titanium oxide.

In other words, in the coated titanium oxide, the amount of the silicon oxide quantitatively determined by X-ray fluorescence analysis in terms of SiO₂ is preferably 0.1% to 7% by weight, more preferably 0.1% to 6% by weight, and particularly preferably 0.1% to 5% by weight, assuming that the total weight of titanium dioxide in the coated titanium oxide is 100% by weight.

If the amount of the silicon oxide in the coating layer of the coated titanium oxide is excessively small, the photocatalysis of the titanium oxide is not sufficiently suppressed, which causes coloration of the polyolefin-based resin resulting from the degradation of the polyolefin-based resin. Consequently, the light reflection performance of the light reflection plate may degrade. If the amount of the silicon oxide in the coating layer of the coated titanium oxide is excessively large, the coating layer absorbs visible light, which degrades the light reflection caused by the titanium oxide. Consequently, the light reflection performance of the light reflection plate may degrade.

In the coating layer of the coated titanium oxide, the amount of the aluminum oxide quantitatively determined by X-ray fluorescence analysis in terms of Al₂O₃ and the amount of the silicon oxide quantitatively determined by X-ray fluorescence analysis in terms of SiO₂ are measured with an X-ray fluorescence analyzer.

Specifically, the above amounts can be measured using, for example, an X-ray fluorescence analyzer “RIX-2100” (trade name) commercially available from Rigaku Corporation under the following conditions: X-ray tube (vertical Rh/Cr tube (3/2.4 kW)), analysis diameter (10 mmφ), slit (standard), analyzing crystals (TAP (F to Mg), PET (Al, Si), Ge (P to Cl), LiF (K to U)), detectors (F—PC (F to Ca), SC (Ti to U)), measurement mode (bulk method, 10 m-Cr, no balance component).

The details of the measurement are described below. A double-faced carbon adhesive tape is attached to a carbon mount, and a coated titanium oxide is attached to the double-faced carbon adhesive tape. The amount of the coated titanium oxide attached is not particularly limited, but is about 0.1 g as a standard. The coated titanium oxide is uniformly attached to an imaginary planar square region with 12 mm sides, the region being fixed on the double-faced carbon adhesive tape. The double-faced carbon adhesive tape is preferably covered with the coated titanium oxide such that the double-faced carbon adhesive tape in the imaginary region is invisible.

The entire surface of the carbon mount is covered with a polypropylene film to prevent the coated titanium oxide from scattering, whereby an X-ray measurement specimen is prepared. The amount of the aluminum oxide in terms of Al₂O₃ and the amount of the silicon oxide in terms of SiO₂ in the coating layer of the coated titanium oxide can be measured with the X-ray fluorescence analyzer using the X-ray measurement specimen under the above measurement conditions.

The carbon mount is made of carbon and may have a cylindrical shape with a diameter of 26 mm and a height of 7 mm. For example, the carbon mount is commercially available from Okenshoji Co., Ltd. as a trade name “Carbon Specimen Mount” (code No. #15-1046). An example of the double-faced carbon adhesive tape that can be used is a conductive double-faced carbon tape for SEM (width 12 mm, length 20 m) commercially available from Okenshoji Co., Ltd. An example of the polypropylene film that can be used is a polypropylene film 6 μm in thickness commercially available from Rigaku Industrial Corporation as a trade name “Cell Sheet Cat. No. 3377P3”.

A method for producing the coated titanium oxide will now be described. In the production of the coated titanium oxide, untreated titanium oxide is dispersed in water or a medium mainly composed of water to prepare a water-based slurry. The titanium oxide may be preliminarily ground using a wet grinding mill such as a vertical sand mill, a horizontal sand mill, or a ball mill in accordance with the degree of agglomeration of the titanium oxide.

The water-based slurry preferably has a pH of 9 or more because the titanium oxide can be stably dispersed in the water-based slurry. A dispersing agent may be further added to the water-based slurry. Examples of the dispersing agent include phosphate compounds such as sodium hexametaphosphate and sodium pyrophosphate and silicate compounds such as sodium silicate and potassium silicate.

Subsequently, a coating layer containing aluminum oxide and silicon oxide is formed on the surface of the titanium oxide. Specifically, at least one of a water-soluble aluminum salt and a water-soluble silicate is added to the water-based slurry. Examples of the water-soluble aluminum salt include sodium aluminate, aluminum sulfate, aluminum nitrate, and aluminum chloride. Examples of the water-soluble silicate include sodium silicate and potassium silicate.

After or during the addition of at least one of a water-soluble aluminum salt and a water-soluble silicate to the water-based slurry, a neutralizer is added thereto. Non-limiting examples of the neutralizer include acidic compounds, e.g., inorganic acids such as sulfuric acid and hydrochloric acid and organic acids such as acetic acid and formic acid; and basic compounds, e.g., hydroxides and carbonates of alkali metals and alkaline-earth metals, and ammonium compounds.

A coating layer containing silicon oxide can be formed on the surface of titanium oxide by a method disclosed in, for example, Japanese Unexamined Patent Application Publication No. 53-33228 or No. 58-84863.

After the entire surface of the titanium oxide is coated with at least one of aluminum oxide and silicon oxide in the same manner as above, the titanium oxide is separated from the water-based slurry by filtration using a publicly known filtering device such as a rotary press or a filter press. If necessary, the titanium oxide is washed to remove soluble salts.

When the water-soluble aluminum salt and the water-soluble silicate are added to the water-based slurry, a coated titanium oxide obtained by coating the surface of the titanium oxide with a coating layer containing aluminum oxide and silicon oxide can be produced in the same manner as above.

When only one of the water-soluble aluminum salt and the water-soluble silicate is added to the water-based slurry, the water-based slurry is prepared in the same manner as above using a titanium oxide coated with one of the water-soluble aluminum salt and water-soluble silicate. The other of the water-soluble aluminum salt and water-soluble silicate is added to the water-based slurry in the same manner as above to coat the surface of the titanium oxide with the other of the water-soluble aluminum salt and water-soluble silicate. Thus, a coated titanium oxide obtained by coating the surface of the titanium oxide With a coating layer containing aluminum oxide and silicon oxide can be produced.

The titanium oxide coated with one of the water-soluble aluminum salt and water-soluble silicate is preferably ground in accordance with the degree of agglomeration of the coated titanium oxide using, for example, an impact mill such as a hammer mill or a pin mill, a grinding mill such as a disintegrator, an air grinding mill such as a jet mill, a spray drying machine such as a spray dryer, or a wet grinding mill such as a vertical sand mill, a horizontal sand mill, or a ball mill. The impact mill and grinding mill are more preferably used.

If the content of the coated titanium oxide in the light reflection plate is excessively low, the light reflection performance of the light reflection plate may degrade. If the content of the coated titanium oxide in the light reflection plate is excessively high, an increase in the content of the coated titanium oxide does not correspond to an improvement in the light reflection performance of the light reflection plate and such an increase in the content may degrade the lightweight property of the light reflection plate. Therefore, the content of the coated titanium oxide in the light reflection plate is limited to 20 to 120 parts by weight and is preferably 30 to 120 parts by weight and more preferably 30 to 100 parts by weight relative to 100 parts by weight of the polyolefin-based resin.

For the purpose of improving the dispersibility of the coated titanium oxide in the polyolefin-based resin, the surface of the coated titanium oxide is preferably treated with at least one coupling agent selected from the group consisting of a titanium coupling agent and a silane coupling agent, a siloxane compound, or a polyhydric alcohol. The surface of the coated titanium oxide is more preferably treated with a silane coupling agent.

The silane coupling agent is, for example, an alkoxysilane having an alkyl group, an alkenyl group, an amino group, an aryl group, or an epoxy group, a chlorosilane, or a polyalkoxyalkylsiloxane. Specific examples of the silane coupling agent include aminosilane couplig agents such as n-β-(aminoethyl)-γ-aminopropylmethyldimethoxysilane, n-β-(aminoethyl)-γ-aminopropylmethyltrimethoxysilane, n-β-(aminoethyl)-γ-aminopropylmethyltriethoxysilane, 7-aminopropyltriethoxysilane, γ-aminopropyltrimethoxysilane, and n-phenyl-γ-aminopropyltrimethoxysilane; and alkylsilane coupling agents such as dimethyldimethoxysilane, methyltrimethoxysilane, ethyltrimethoxysilane, propyltrimethoxysilane, n-butyltrimethoxysilane, n-butyltriethoxysilane, n-butylmethyldimethoxysilane, n-butylmethyldiethoxysilane, isobutyltrimethoxysilane, isobutyltriethoxysilane, isobutylmethyldimethoxysilane, tert-butyltrimethoxysilane, tert-butyltriethoxysilane, tert-butylmethyldimethoxysilane, and tert-butylmethyldiethoxysilane. The aminosilane coupling agents are preferably used. These silane coupling agents may be used alone or in combination of two or more.

Examples of the siloxane compound include dimethyl silicone, methyl hydrogen silicone, and an alkyl-modified silicone. Examples of the polyhydric alcohol include trimethylol ethane, trimethylol propane, tripropanol ethane, pentaerythritol, and pentaerythrit. Among them, trimethylol ethane and trimethylol propane are preferably used. These siloxane compounds and polyhydric alcohols may be used alone or in combination of two or more.

The above coated titanium oxide is commercially available from E.I. Dupont de Nemours & Co., SCM Corporation, Kerr-McGee Co., CanadeanTitanium Pigments Ltd., Tioxide of Canada Ltd., Pigmentos y Productos Quimicos, S.A. de C.V, Tibras Titanos S.A., Tioxide International Ltd., SCM Corp., Kronos Titan GmbH, NL Chemical SA/NV, Tioxide, TDF Tiofine BV, ISHIHARA SANGYO KAISHA, LTD., TAYCA CORPORATION, Sakai Chemical Industry Co., Ltd., FURUKAWA CO., LTD., TOHKEM PRODUCTS CORPORATION, Titan Kogyo, Ltd., Fuji Titanium Industry Co., Ltd., Han Kook Titanium Ind. Co., Ltd, China Metalworking Corporation, and ISK Taiwan Co., Ltd.

The light reflection plate of the present invention includes a polyolefin-based resin in addition to the above-described coated titanium oxide. Non-limiting examples of the polyolefin-based resin include polyethylene-based resins and polypropylene-based resins. These polyolefin-based resins may be used alone or in combination of two or more.

Examples of the polyethylene-based resins include low-density polyethylene, linear low-density polyethylene, high-density polyethylene, and medium-density polyethylene.

Examples of the polypropylene-based resin include homopolypropylene, ethylene-propylene copolymers, and propylene-α-olefin copolymers. When the light reflection plate is a foamed light reflection plate, the polypropylene-based resin is preferably a high melt strength polypropylene-based resin disclosed in Japanese Patent No. 2521388 or Japanese Unexamined Patent Application Publication No. 2001-226510.

The ethylene-propylene copolymer and propylene-α-olefin copolymer may be a random copolymer or a block copolymer. The content of an ethylene component in the ethylene-propylene copolymer is preferably 0.5% to 30% by weight and more preferably 1% to 10% by weight. The content of an α-olefin component in the propylene-α-olefin copolymer is preferably 0.5% to 30% by weight and more preferably 1% to 10% by weight.

An example of the a-olefin is an a-olefin having 4 to 10 carbon atoms, such as 1-butene, 1-pentene, 4-methyl-1-pentene, 1-hexene, 1-heptene, or 1-octene.

Among the polyolefin-based resins, a polypropylene-based resin is preferred and homopolypropylene is particularly preferred. The coated titanium oxide can be particularly finely dispersed in the polypropylene-based resin. In particular, use of homopolypropylene provides a light reflection plate in which the coated titanium oxide is finely dispersed. In addition, a volatile component is not generated even when the light reflection plate is heated, which does not fog a glass plate included in a liquid crystal display apparatus.

The light reflection plate may contain a primary antioxidant. The primary antioxidant is a stabilizer that terminates a radical reaction by capturing a radical generated by heat or light. A phenol-based antioxidant is preferably used as the primary antioxidant because it exhibits a large effect of suppressing a decrease in the light reflectance of the light reflection plate.

Examples of the phenol-based antioxidant include 2,6-di-t-butyl-4-methylphenol, n-octadecyl-3-(3′,5′-di-t-butyl-4′-hydroxyphenyl)propionate, tetrakis[3-(3,5-di-t-butyl-4-hydroxyphenyl)propionyloxymethyl]methane, tris[N-(3,5-di-t-butyl-4-hydroxybenzyl)]isocyanurate, butylidene-1,1-bis(2-methyl-4-hydroxy-5-t-butylphenyl), triethylene glycol bis[3-(3-t-butyl-4-hydroxy-5-methylphenyl)propionate], and 3,9-bis{2-[3-(3-t-butyl-4-hydroxy-5-methylphenyl)propionyloxy]-1,1-dimethylethyl}-2,4,8,10-tetraoxaspiro[5.5]undecane. These phenol-based antioxidants may be used alone or in combination of two or more.

If the content of the primary antioxidant in the light reflection plate is low, a decrease in the light reflectance of the light reflection plate sometimes cannot be suppressed. On the other hand, even if the content of the primary antioxidant in the light reflection plate is high, an effect of suppressing a decrease in the light reflectance of the light reflection plate does not change, and furthermore the light reflectance of the light reflection plate may decrease as a result of the coloration of the primary antioxidant itself. Therefore, the content of the primary antioxidant in the light reflection plate is preferably 0.01 to 0.5 parts by weight, more preferably 0.01 to 0.3 parts by weight, and particularly preferably 0.01 to 0.2 parts by weight relative to 100 parts by weight of the polyolefin-based resin.

The light reflection plate may contain a secondary antioxidant. The secondary antioxidant can prevent autoxidation by causing ion decomposition of a hydroperoxide (ROOH), which is an intermediate formed as a result of degradation of the polyolefin-based resin due to autoxidation caused by heat or light. The secondary antioxidant is preferably a phosphorus-based antioxidant or a sulfur-based antioxidant and more preferably a phosphorus-based antioxidant. Such a phosphorus-based antioxidant and sulfur-based antioxidant provide a large effect of suppressing a decrease in the light reflectance of the light reflection plate.

Examples of the phosphorus-based antioxidant include tris(nonylphenyl)phosphite, tris(2,4-di-t-butylphenyl)phosphite, distearylpentaerythritol diphosphite, bis(2,4-di-t-butylphenyl)pentaerythritol phosphite, and 2,2-methylenebis(4,6-di-t-butylphenyl)-4,4′-biphenylene diphosphonite. These phosphorus-based antioxidants may be used alone or in combination of two or more.

Examples of the sulfur-based antioxidant include dilauryl-3,3′-thiodipropionate, dimyristyl-3,3′-thiodipropionate, distearyl-3,3′-thiodipropionate, and pentaerythritoltetrakis(3-laurylthiopropionate). These sulfur-based antioxidants may be used alone or in combination of two or more.

If the content of the secondary antioxidant in the light reflection plate is excessively low, a decrease in the light reflectance of the light reflection plate sometimes cannot be suppressed. On the other hand, even if the content of the secondary antioxidant in the light reflection plate is excessively high, an effect of suppressing a decrease in the light reflectance of the light reflection plate may not change. Therefore, the content of the secondary antioxidant in the light reflection plate is preferably 0.01 to 0.5 parts by weight, more preferably 0.01 to 0.3 parts by weight, and particularly preferably 0.01 to 0.2 parts by weight relative to 100 parts by weight of the polyolefin-based resin.

The light reflection plate may further contain an ultraviolet absorber. Examples of the ultraviolet absorber include benzotriazole-based ultraviolet absorbers such as 2-(2′-hydroxy-5′-methylphenyl)benzotriazole, 2-[2′-hydroxy-3′,5′-bis(α,α-dimethylbenzyl)phenyl]benzotriazole, 2-(2′-hydroxy-3′,5-di-t-butylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-3′,5′-di-t-amyl)benzotriazole, 2-(2′-hydroxy-5′-t-octylphenyl)benzotriazole, and 2,2′-methylenebis[4-(1,1,3,3-tetramethylbutyl)-6-(2N-benzotriazol-2-yl)phenol]; benzophenone-based ultraviolet absorbers such as 2,4-dihydroxybenzophenone, 2-hydroxy-4-methoxybenzophenone, 2-hydroxy-4-methoxybenzophenone-5-sulfonic acid, 2-hydroxy-4-n-octylbenzophenone, 2-hydroxy-4-n-dodecyloxybenzophenone, bis(5-benzoyl-4-hydroxy-2-methoxyphenyl)methane, 2,2′-dihydroxy-4-methoxybenzophenone, and 2,2′-dihydroxy-4,4′-dimethoxybenzophenone; salicylate-based ultraviolet absorbers such as phenyl salicylate and 4-t-butylphenyl salicylate; cyanoacrylate-based ultraviolet absorbers such as ethyl-2-cyano-3,3-diphenylacrylate and 2-ethylhexyl-2-cyano-3,3′-diphenylacrylate; oxalic acid anilide-based ultraviolet absorbers such as 2-ethoxy-3-t-butyl-2′-ethyloxalic acid bisanilide and 2-ethoxy-2′-ethyloxalic acid bisanilide; benzoate-based ultraviolet absorbers such as 2,4-di-t-butylphenyl-3,5-di-t-butyl-4-hydroxybenzoate; and triazine-based ultraviolet absorbers such as 2-[4,6-bis(2,4-dimethylphenyl)-1,3,5-triazin-2-yl]-5-hydroxyphenol, 2-(2,4-dihydroxyphenyl)-4,6-bis(2,4-dimethylphenyl)-1,3,5-triazine, and 2,4-bis(2-hydroxy-4-butoxyphenyl)-6-(2,4-dibutoxyphenyl)-1,3,5-triazine. Among them, a benzotriazole-based ultraviolet absorber is preferred because a decrease in the light reflectance of the light reflection plate can be effectively suppressed. These ultraviolet absorbers may be used alone or in combination of two or more.

The molecular weight of the ultraviolet absorber is preferably 250 or more, more preferably 300 to 500, and particularly preferably 400 to 500. When a light reflection plate is produced by extruding a resin composition for forming light reflection plates, an ultraviolet absorber having a molecular weight of less than 250 easily volatilizes from a surface of an extruded material of the resin composition for forming light reflection plates. This volatilization of the ultraviolet absorber may cause defects such as uneven gloss, roughness, and cracking on the surface of a light reflection plate to be produced. A formed body of the light reflection plate having such defects cannot uniformly exhibit high light reflection performance.

If the content of the ultraviolet absorber in the light reflection plate is excessively low, a decrease in the light reflectance of the light reflection plate sometimes cannot be suppressed. On the other hand, even if the content of the ultraviolet absorber in the light reflection plate is excessively high, an effect of suppressing a decrease in the light reflectance of the light reflection plate may not change. Therefore, the content of the ultraviolet absorber in the light reflection plate is preferably 0.01 to 0.5 parts by weight, more preferably 0.01 to 0.3 parts by weight, and particularly preferably 0.01 to 0.2 parts by weight relative to 100 parts by weight of the polyolefin-based resin.

The light reflection plate may further contain a hindered amine-based light stabilizer. Non-limiting examples of the hindered amine-based light stabilizer include bis(2,2,6,6-tetramethyl-4-piperidinyl)sebacate, bis(N-methyl-2,2,6,6-tetramethyl-4-piperidinyl)sebacate, bis(1,2,2,6,6-pentamethyl-4-piperidinyl)-2-(3,5-di-t-butyl-4-hydroxybenzyl)-2-n-butyl malonate, tetrakis(2,2,6,6-tetramethyl-4-piperidyl)-1,2,3,4-butane tetracarboxylate, tetrakis(1,2,2,6,6-pentamethyl-4-piperidyl)-1,2,3,4-butane tetracarboxylate, a mixture of (2,2,6,6-tetramethyl-4-piperidyl)-1,2,3,4-butane tetracarboxylate and (2,2,6,6-tetramethyl-4-tridecyl)-1,2,3,4-butane tetracarboxylate, a mixture of (1,2,2,6,6-pentamethyl-4-piperidyl)-1,2,3,4-butane tetracarboxylate and (1,2,2,6,6-pentamethyl-4-tridecyl)-1,2,3,4-butane tetracarboxylate, a mixture of {2,2,6,6-tetramethyl-4-piperidyl-3,9-[2,4,8,10-tetraoxaspiro(5.5)undecane]diethyl}-1,2,3,4-butane tetracarboxylate and {2,2,6,6-tetramethyl-β,β,β′,β′-tetramethyl-3,9-[2,4,8,10-tetraoxaspiro(5.5)undecane]diethyl}-1,2,3,4-butane tetracarboxylate, a mixture of {1,2,2,6,6-pentamethyl-4-piperidyl-3,9-[2,4,8,10-tetraoxaspiro(5.5)undecane]diethyl}-1,2,3,4-butane tetracarboxylate and {1,2,2,6,6-pentamethyl-β,ββ′,β′-tetramethyl-3,9-[2,4,8,10-tetraoxaspiro(5.5)undecane]diethyl}-1,2,3,4-butane tetracarboxylate, poly[6-(1,1,3,3-tetramethylbutyl)imino-1,3,5-triazin-2,4-diyl], [(2,2,6,6-tetramethyl-4-piperidyl)imino]hexamethylene[(2,2,6,6-tetramethyl-4-piperidyl)imino], a mixture of 4-hydroxy-2,2,6,6-tetramethyl-1-piperidine ethanol and a dimethyl succinate polymer, and N,N′,N″,N′″-tetrakis{4,6-bis[butyl-(N-methyl-2,2,6,6-tetramethylpiperidin-4-yl)amino]-triazin-2-yl}-4,7-diazadecane-1,10-diamine. These hindered amine-based light stabilizers may be used alone or in combination of two or more.

If the content of the hindered amine-based light stabilizer in the light reflection plate is excessively low, a decrease in the light reflectance of the light reflection plate sometimes cannot be suppressed. On the other hand, even if the content of the hindered amine-based light stabilizer in the light reflection plate is excessively high, an effect of suppressing a decrease in the light reflectance of the light reflection plate does not change, and furthermore the light reflectance of the light reflection plate may decrease as a result of the coloration of the hindered amine-based light stabilizer itself. Therefore, the content of the hindered amine-based light stabilizer in the light reflection plate is preferably 0.01 to 0.5 parts by weight, more preferably 0.01 to 0.3 parts by weight, and particularly preferably 0.01 to 0.2 parts by weight relative to 100 parts by weight of the polyolefin-based resin.

Herein, the degradation of the polyolefin-based resin is caused by cleavage of a polymer main chain. Specifically, a radical generated due to heat, light, or the like reacts with oxygen to form a peroxy radical. The peroxy radical extracts hydrogen from the main chain to form a hydroperoxide. Subsequently, the hydroperoxide is decomposed due to heat, light, or the like to form an alkoxy radical. The alkoxy radical cleaves the polymer main chain, which results in the generation of a radical. This reaction cycle repeatedly occurs and thus the polymer main chain is cleaved. As a result, the molecular weight of the polyolefin-based resin decreases and the polyolefin-based resin is degraded. This degradation of the polyolefin-based resin causes yellowing of the polyolefin-based resin, which decreases the light reflectance of the light reflection plate.

Therefore, as described above, the light reflection plate of the present invention uses the coated titanium oxide obtained by coating the surface of titanium oxide with the coating layer containing aluminum oxide and silicon oxide. The coating layer avoids the contact between the titanium oxide and the polyolefin-based resin, blocks ultraviolet light incident upon the titanium oxide as much as possible, prevents the oxidative decomposition of the polyolefin-based resin due to photocatalysis of the titanium oxide, and prevents the discoloration to dark gray caused by an increase in the number of oxygen defects due to the photochemical change in a titanium oxide crystal.

In addition, as described above, the yellowing resulting from the degradation of the polyolefin-based resin and the photochemical change of the coated titanium oxide are suppressed by adding the primary antioxidant, secondary antioxidant, ultraviolet absorber, and hindered amine-based light stabilizer to the light reflection plate constituting the light reflection plate. Consequently, the decrease in the light reflectance of the light reflection plate can be further prevented.

Specifically, the photostabilizing effect of the polyolefin-based resin provided by the addition of the ultraviolet absorber and hindered amine-based light stabilizer more effectively prevents the yellowing resulting from the degradation of the polyolefin-based resin, preventa the oxidative decomposition of the polyolefin-based resin due to the activation of titanium oxide, and further suppresses the photochemical change.

On the other hand, as described above, the ultraviolet absorber and hindered amine-based light stabilizer have an effect of suppressing the oxidative decomposition of the polyolefin-based resin due to titanium oxide, but the effect of suppression is not sufficient. The ultraviolet absorber and hindered amine-based light stabilizer themselves may be subjected to oxidative decomposition by titanium oxide.

The addition of the primary antioxidant and secondary antioxidant in addition to the ultraviolet absorber and hindered amine-based light stabilizer results in the capture of a radical and the ion decomposition of the hydroperoxide, which photostabilizes the polyolefin-based resin. This prevents the yellowing resulting from the degradation of the polyolefin-based resin with more certainty and also prevents the oxidative decomposition of the ultraviolet absorber and hindered amine-based light stabilizer due to titanium oxide with more certainty.

In other words, the addition of the primary antioxidant and secondary antioxidant prevents the yellowing resulting from the degradation of the polyolefin-based resin and also prevents the decomposition of the ultraviolet absorber and hindered amine-based light stabilizer due to titanium dioxide with more certainty. These protected ultraviolet absorber and hindered amine-based light stabilizer prevent the oxidative decomposition of the polyolefin-based resin due to titanium oxide and suppress the photochemical change with more certainty. As a result, the initial light reflectance can be prevented, with more certainty, from decreasing within a short time and high light reflectance can be maintained for a long time.

The light reflection plate may further contain a copper inhibitor (metal deactivator). As a result of the addition of the copper inhibitor to the light reflection plate, even when the light reflection plate contacts a metal such as copper or a heavy metal ion such as a copper ion acts on the light reflection plate, a copper ion serving as a degradation accelerator can be captured in the form of a chelate compound. In the case where the light reflection plate is incorporated into, for example, various liquid crystal display apparatuses and illuminating apparatuses, even when the light reflection plate contacts a metal such as copper, the yellowing resulting from the degradation of the polyolefin-based resin can be prevented.

Examples of the copper inhibitor (metal deactivator) include hydrazine-based compounds such as N,N-bis[3-(3,5-di-t-butyl-4-hydroxyphenyl)propionyl]hydrazine; and 3-(3,5-di-tetrabutyl-4-hydroxyphenyl)propionyl dihydrazide.

If the content of the copper inhibitor (metal deactivator) in the light reflection plate is excessively low, the effect produced by adding the copper inhibitor is sometimes not realized. If the content of the copper inhibitor (metal deactivator) in the light reflection plate is excessively high, the light reflectance of the light reflection plate sometimes decreases. Therefore, the content of the copper inhibitor (metal deactivator) in the light reflection plate is preferably 0.1 to 1.0 part by weight relative to 100 parts by weight of the polyolefin-based resin.

The light reflection plate may contain an antistatic agent. The addition of the antistatic agent can prevent the electrification of the light reflection plate, which prevents dust and dirt from adhering to the light reflection plate. Thus, the decrease in the light reflectance of the light reflection plate can be prevented.

Examples of the antistatic agent include polymer antistatic agents such as polyethylene oxide, polypropylene oxide, polyethylene glycol, polyester amide, polyether ester amide, ionomers of ethylene-methacrylic acid copolymers or the like, quaternary ammonium salts of polyethylene glycol-methacrylate copolymers or the like, and block copolymers having a structure in which an olefin block and a hydrophilic block are alternately bonded to each other in a repeated manner, the block copolymers being disclosed in Japanese Unexamined Patent Application Publication No. 2001-278985; inorganic salts; polyhydric alcohols; metal compounds; and carbon.

If the content of an antistatic agent other than the polymer antistatic agent in the light reflection plate is excessively low, the effect produced by adding the antistatic agent is sometimes not realized. On the other hand, if the content of an antistatic agent other than the polymer antistatic agent in the light reflection plate is excessively high, the effect corresponding to the concentration of the antistatic agent is not realized and moreover the effect of the antistatic agent is decreased. In other cases, considerable bleeding out, discoloration, and yellowing due to light may occur. Therefore, the content of the antistatic agent other than the polymer antistatic agent in the light reflection plate is preferably 0.1 to 2 parts by weight relative to 100 parts by weight of the polyolefin-based resin.

The content of the polymer antistatic agent in the light reflection plate is preferably 5 to 50 parts by weight relative to 100 parts by weight of the polyolefin-based resin for the reasons described above.

In addition to the copper inhibitor (metal deactivator) and antistatic agent, the light reflection plate may further contain a dispersing agent such as a metallic soap of stearic acid, a quencher, a lactone-based process stabilizer, a fluorescent whitening agent, and a nucleating agent.

If the thickness of the light reflection plate is excessively small, the rigidity of the light reflection plate decreases and consequently the light reflection plate may be bent. In addition, when the light reflection plate is thermoformed into a desired shape, a thin portion may be easily formed. If the thickness of the light reflection plate is excessively large, the thickness and weight of a device into which the light reflection plate is incorporated may increase. Therefore, the thickness of the light reflection plate is preferably 0.1 to 1.5 mm, more preferably 0.1 to 0.8 mm, and particularly preferably 0.1 to 0.6 mm. The shape of the light reflection plate is not particularly limited, but is preferably a sheet-like shape.

A method for producing the light reflection plate of the present invention will now be described. The light reflection plate of the present invention is produced using a resin composition for forming light reflection plates, the resin composition containing 100 parts by weight of polyolefin-based resin and 20 to 120 parts by weight of a coated titanium oxide.

In order that the coated titanium oxide in the light reflection plate may be constituted by agglomerated particles whose number is within a particular range and which have a particle size of 0.4 μm or more and primary particles which are finely dispersed in the light reflection plate without being agglomerated in a cross section of the light reflection plate in a thickness direction, particles of the coated titanium oxide having the above primary particle size are preferably finely dispersed in the resin composition. However, it is sometimes difficult to finely disperse the particles of the coated titanium oxide having the above primary particle size because the particles of the coated titanium oxide are fine particles which easily agglomerate. Therefore, a coated titanium oxide dried by vaporizing moisture or decreasing the amount of moisture contained in the coated titanium oxide through preliminary heating of the coated titanium oxide having the above primary particle size is preferably used.

The silicon oxide and aluminum oxide contained in the coating layer of the coated titanium oxide easily form a hydrate through addition to moisture. Therefore, in the state in which the surface of the coated titanium oxide is exposed to an air atmosphere, the silicon oxide and aluminum oxide in the coating layer of the coated titanium oxide form a hydrate through addition to moisture in the air atmosphere, and thus the coated titanium oxide contains water of hydration. According to the studies conducted by the inventors of the present invention, such a coated titanium oxide containing water of hydration easily causes agglomeration because of its high cohesive power between particles of the coated titanium oxide. On the other hand, in a coated titanium oxide dried by removing water of hydration or decreasing the amount of water of hydration contained in the coated titanium oxide, the agglomeration is considerably suppressed and only some of particles of the coated titanium oxide form agglomerated particles. Thus, the inventors have found that the light reflection plate of the present invention is easily produced by using such a dried coated titanium oxide. Therefore, the coated titanium oxide dried by removing moisture or decreasing the amount of moisture through preliminary heating of the coated titanium oxide having the above primary particle size is preferably used for the production of the light reflection plate.

Accordingly, the light reflection plate of the present invention is preferably produced using a resin composition for forming light reflection plates, the resin composition containing 100 parts by weight of a polyolefin-based resin and 20 to 120 parts by weight of a coated titanium oxide that has a moisture content of 0.5% by weight or less and is obtained by coating the surface of titanium oxide with a coating layer containing aluminum oxide and silicon oxide.

If the moisture content of the coated titanium oxide is high, the coated titanium oxide easily agglomerates and the particle size of the agglomerated particles increases. As a result, large projections are partially formed on the surface of the light reflection plate by the agglomerated particles, which sometimes makes the light diffusibility of the light reflection plate uneven. Therefore, the moisture content of the coated titanium oxide is preferably 0.5% by weight or less and more preferably 0.4% by weight or less. If the moisture content of the coated titanium oxide is low, the number of agglomerated particles of the coated titanium oxide contained in an optical film per unit area becomes excessively small, and the light diffusibility of the optical film is sometimes not sufficiently provided. Therefore, the moisture content of the coated titanium oxide is preferably 0.01% by weight or more.

In order to remove the water of hydration contained in the coated titanium oxide, the moisture is removed or the amount of moisture is decreased through the vaporization of the water of hydration by heating the coated titanium oxide preferably at 50° C. to 140° C. and more preferably at 90° C. to 120° C. The heating time is preferably 2 to 8 hours and more preferably 3 to 5 hours.

In addition to the polyolefin-based resin and the coated titanium oxide whose moisture content is 0.5% by weight or less, the resin composition for forming light reflection plates preferably contains, when necessary, other additives such as a primary antioxidant, a secondary antioxidant, an ultraviolet absorber, and a hindered amine-based light stabilizer. The descriptions concerning the polyolefin-based resin, the coated titanium oxide, and the other additives such as a primary antioxidant, a secondary antioxidant, an ultraviolet absorber, and a hindered amine-based light stabilizer used in the resin composition for forming light reflection plates are the same as above.

The resin composition for forming light reflection plates preferably contains a master batch prepared in advance so as to contain the polyolefin-based resin and the coated titanium oxide, the polyolefin-based resin, and, when necessary, the other additives such as the primary antioxidant, secondary antioxidant, ultraviolet absorber, and hindered amine-based light stabilizer. By using the master batch containing the coated titanium oxide, the dispersibility of the coated titanium oxide in the resin composition for forming light reflection plates can be improved. In the master batch, the coated titanium oxide whose moisture content is 0.5% by weight or less is fully coated with the polyolefin-based resin, and there are almost no particles of the coated titanium oxide exposed without being coated with the polyolefin-based resin. Therefore, even if the master batch is left to stand for a long time, the moisture content of the coated titanium oxide contained in the master batch does not change and is kept at a substantially constant value.

A method for preparing the master batch is not particularly limited, but the following method is preferably employed. That is, the coated titanium oxide and the polyolefin-based resin are supplied to an extruder at a particular weight ratio and melt-kneaded to obtain a melt-kneaded material. The melt-kneaded material is then extruded by the extruder. Also in the case where the master batch is used, the master batch is preferably prepared using the coated titanium oxide whose moisture content is adjusted to be 0.5% by weight or less by performing preliminary drying by heating as described above.

When the melt-kneaded material is obtained by melt-kneading the coated titanium oxide and polyolefin-based resin in the extruder, an extruder including volatile matter-removing means is preferably used to discharge, from the extruder, volatile matter generated from the melt-kneaded material during the melt-kneading. By employing such a method, a larger amount of water of hydration contained in the coating layer of the coated titanium oxide can be removed.

An example of the extruder including the volatile matter-removing means is a vent-type extruder including a vent for discharging a gas located inside a cylinder to the outside, the vent being disposed in an intermediate portion of the cylinder of the extruder in which the coated titanium oxide and polyolefin-based resin are melt-kneaded. In the vent-type extruder, the gas located inside the cylinder can be discharged to the outside by sucking the gas through the vent using a vacuum pump or the like.

In the case where the gas is sucked through the vent, the pressure in the cylinder is preferably set to be 7.5 to 225 mmHg (1 to 30 kPa) and more preferably 22.5 to 150 mmHg (3 to 20 kPa). When the pressure in the cylinder is within the above range, the water of hydration contained in the coated titanium oxide contained in the melt-kneaded material can be removed during the melt-kneading. The temperature of the melt-kneaded material during the melt-kneading is preferably 180° C. to 290° C. and more preferably 180° C. to 270° C.

The resin composition for forming light reflection plates is preferably produced by supplying, to the extruder, the polyolefin-based resin, the coated titanium oxide whose moisture content is preferably 0.5% by weight or less, and, when necessary, the other additives such as the primary antioxidant, secondary antioxidant, ultraviolet absorber, and hindered amine-based light stabilizer and performing melt-kneading so that a light reflection plate to be produced in the end contains the above components at a desired weight ratio. In the case where the master batch is used, the resin composition for forming light reflection plates is preferably produced by supplying, to the extruder, the master batch containing the polyolefin-based resin and the coated titanium oxide whose moisture content is preferably 0.5% by weight or less, the polyolefin-based resin, and, when necessary, the other additives such as the primary antioxidant, secondary antioxidant, ultraviolet absorber, and hindered amine-based light stabilizer and performing melt-kneading so that a light reflection plate to be produced in the end contains the above components at a desired weight ratio.

When the coated titanium oxide and the polyolefin-based resin are melt-kneaded in the extruder or when, if used, the master batch and the polyolefin-based resin are melt-kneaded in the extruder to obtain the resin composition for forming light reflection plates, the extruder including the volatile matter-removing means, such as a vent-type extruder, is also preferably used to discharge, from the extruder, volatile matter generated from the resin composition during the melt-kneading of the resin composition. By employing such a method, a larger amount of water of hydration contained in the coating layer of the coated titanium oxide can be removed. Note that the vent-type extruder is the same as that in the description of the master batch.

In the case where the gas is sucked through the vent of the vent-type extruder, the pressure in the cylinder is preferably set to be 7.5 to 225 mmHg (1 to 30 kPa) and more preferably 22.5 to 150 mmHg (3 to 20 kPa). When the pressure in the cylinder is within the above range, the water of hydration contained in the coated titanium oxide contained in the resin composition can be removed during the melt-kneading. The temperature of the resin composition during the melt-kneading is preferably 180° C. to 290° C. and more preferably 180° C. to 270° C.

The resin composition for forming light reflection plates is preferably produced by melt-kneading, for example, the polyolefin-based resin and the coated titanium oxide. After that, the resin composition for forming light reflection plates may be formed into a particular shape such as a pellet-like shape. In such a formed resin composition for forming light reflection plates, the coated titanium oxide whose moisture content is preferably 0.5% by weight or less is fully coated with the polyolefin-based resin, and there are almost no particles of the coated titanium oxide exposed without being coated with the polyolefin-based resin. Therefore, even if the formed resin composition for forming light reflection plates is left to stand for a long time, the moisture content of the coated titanium oxide contained in the resin composition for forming light reflection plates does not change and is kept at a substantially constant value.

The resin composition for forming light reflection plates can be formed into a pellet by, for example, the following method. The coated titanium oxide and the polyolefin-based resin are supplied to an extruder and melt-kneaded to obtain a resin composition for forming light reflection plates. The resin composition for forming light reflection plates is extruded into a strand from the extruder, and then the strand is cut into pellets each having a certain length. In the case where the master batch is used, the master batch and the polyolefin-based resin are supplied to an extruder and melt-kneaded to obtain a resin composition for forming light reflection plates. The resin composition for forming light reflection plates is extruded into a strand from the extruder, and then the strand is cut into pellets each having a certain length.

By forming the above resin composition for forming light reflection plates into a sheet, a light reflection plate of the present invention in the form of a non-foamed sheet can be produced. In the forming of the resin composition for forming light reflection plates into a sheet, after the resin composition for forming light reflection plates is melt-kneaded in the extruder, the melt-kneaded material may be extruded from the extruder by a publicly known method such as an inflation method, a T-die method, or a calendering method and is preferably extruded from the extruder by a T-die method. In the forming of the resin composition for forming light reflection plates into a sheet by a T-die method, for example, a T-die is attached to the head of the extruder and the resin composition for forming light reflection plates melt-kneaded in the extruder may be extruded into a sheet through the T-die.

When the polyolefin-based resin, the coated titanium oxide, and the like are supplied to the extruder and melt-kneaded in the extruder to obtain a resin composition for forming light reflection plates, the light reflection plate can be produced by directly extruding the resin composition for forming light reflection plates from the extruder. In the case where the resin composition for forming light reflection plates formed into a particular shape such as a pellet-like shape is used, the light reflection plate can be produced by supplying the formed resin composition for forming light reflection plates to the extruder, performing melt-kneading, and then extruding the melt-kneaded material from the extruder.

When the resin composition for forming light reflection plates is melt-kneaded in the extruder and then formed into a sheet, the extruder including the volatile matter-removing means, such as a vent-type extruder, is also preferably used to discharge, from the extruder, volatile matter generated from the resin composition for forming light reflection plates during the melt-kneading of the resin composition for forming light reflection plates. Note that the vent-type extruder is the same as that in the description of the master batch.

In the case where the gas is sucked through the vent of the vent-type extruder, the pressure in the cylinder is preferably set to be 7.5 to 225 mmHg (1 to 30 kPa) and more preferably 22.5 to 150 mmHg (3 to 20 kPa). When the pressure in the cylinder is within the above range, the water of hydration contained in the coated titanium oxide contained in the resin composition for forming light reflection plates can be removed during the melt-kneading. The temperature of the resin composition for forming light reflection plates during the melt-kneading is preferably 180° C. to 290° C. and more preferably 180° C. to 270° C.

After the resin composition for forming light reflection plates is extruded from the extruder to form a sheet-shaped extruded material and before the extruded material is solidified by cooling to form a light reflection plate, at least one surface of the sheet-shaped extruded material is preferably subjected to mirror surface processing. By performing mirror surface processing, the surface smoothness of the sheet-shaped extruded material is improved and thus a light reflection plate having high light reflection performance can be provided.

The mirror surface processing is preferably performed by, for example, the following method. The sheet-shaped extruded material is supplied between a pair of rolls constituted by a mirror roll whose peripheral surface is a mirror surface and a support roll disposed so as to face the mirror roll, and the mirror roll is pressed against the surface of the sheet-shaped extruded material.

A sheet-shaped support may be laminated on one surface of the light reflection plate of the present invention to form a laminated body. Examples of the support include biaxially stretched polypropylene-based resin films, biaxially stretched polyester-based resin films, polyamide-based resin films, and paper. Among the polypropylene-based resins, polypropylene is preferably used. Among the polyester-based resins, polyethylene terephthalate, polyethylene naphthalate, polybutylene terephthalate, and polylactic acid are preferably used. Among the polyamide-based resins, nylon-6 and nylon-6,6 are preferably used.

Alternatively, a metal foil may be laminated on one surface of the light reflection plate of the present invention to form a laminated body. A preferred example of the metal foil is an aluminum foil. By laminating a metal foil, a laminated body having high light reflection performance is provided.

The method for laminating the support or metal foil on the light reflection plate is not particularly limited. The lamination may be performed by a publicly known process such as a thermal lamination process, a dry lamination process, or an extrusion lamination process.

The light reflection plate of the present invention may be thermoformed into a desired shape in accordance with its applications. The light reflection plate is formed by, for example, vacuum forming or compressed-air forming. Examples of the vacuum forming or compressed-air forming include plug forming, free drawing forming, plug and ridge forming, matched mold forming, straight forming, drape forming, reverse-draw forming, air-slip forming, plug-assist forming, and plug-assist reverse-draw forming. In the above forming methods, a die having a temperature adjusting function is preferably used.

The light reflection plate of the present invention is preferably used in a backlight unit of liquid crystal display apparatuses such as word processors, personal computers, cellular phones, navigation systems, televisions, and portable televisions. As described above, the light reflection plate of the present invention has high light reflection performance and light diffusibility. Therefore, by using such a light reflection plate in a backlight unit of liquid crystal display apparatuses, there can be provided a liquid crystal display apparatus in which a decrease in luminance and the generation of unevenness are suppressed.

When the light reflection plate of the present invention is used in a backlight unit of a liquid crystal display apparatus, the light reflection plate can be incorporated into a direct-type backlight unit, a side-type backlight unit, or a planar light source backlight unit that is included in the liquid crystal display apparatus.

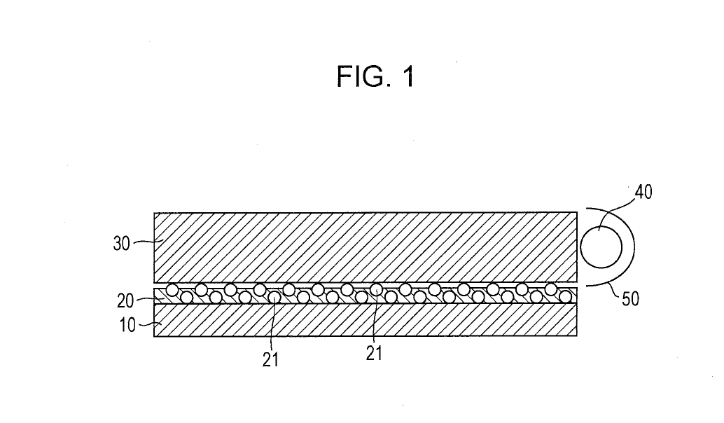

FIG. 1 shows a schematic view of a side-type backlight unit of a liquid crystal display apparatus that uses the light reflection plate of the present invention. The liquid crystal display apparatus shown in FIG. 1 includes a light reflection plate 10, a light diffusion layer 20 laminated on the light reflection plate 10, a light-guiding plate 30 disposed on the light diffusion layer 20, a light source 40 that emits light to the light-guiding plate 30, the light source 40 being disposed on the side of the light-guiding plate 30, and a lamp reflector 50 for reflecting, to the light-guiding plate 30, the light emitted from the light source 40. The light source 40 is, for example, a cold cathode or an LED.

The light diffusion layer 20 is formed by dispersing light-transmissive particles 21 composed of, for example, a styrene resin or an acrylic resin in a binder resin such as a thermoplastic resin. The surface of the light diffusion layer 20 has irregularities formed by the light-transmissive particles 21, and the irregularities contribute to the diffusion of light.

In this liquid crystal display apparatus, light that enters the light-guiding plate 30 from the light source 40 is repeatedly reflected between the front surface and back surface of the light-guiding plate 30 and is guided to the outside of the light-guiding plate 30 from the front surface of the light-guiding plate 30. Light guided to the outside of the light-guiding plate 30 from the back surface of the light-guiding plate 30 is reflected while being uniformly diffused in a direction toward the front surface of the light-guiding plate 30 by the irregularities formed on the surface of the light diffusion layer 20 by the light-transmissive particles 21. Furthermore, when the light guided to the outside of the light-guiding plate 30 from the back surface of the light-guiding plate 30 is transmitted through the light diffusion layer 20, the light is reflected while being uniformly diffused in the direction toward the front surface of the light-guiding plate 30 by the light reflection plate 10. By combining the light-guiding plate 30, the light diffusion layer 20, and the light reflection plate 10 with the light source, the luminance of the liquid crystal display apparatus can be improved and the luminance distribution in an in-plane direction of the liquid crystal display apparatus can be made uniform.

Since the light reflection plate has high light diffusibility as described above, the amount of the light-transmissive particles used in the light diffusion layer can be decreased. A small amount of the light-transmissive particles used in the light diffusion layer can improve the lightweight property and reduce the cost of the light diffusion layer and can also decrease the thickness of the light diffusion layer.

In addition to the above backlight unit of liquid crystal display apparatuses, the light reflection plate of the present invention is also preferably used in illuminating apparatuses for advertisements and signboards. An example of an illuminating apparatus that uses the light reflection plate of the present invention will now be described with reference to the attached drawings.

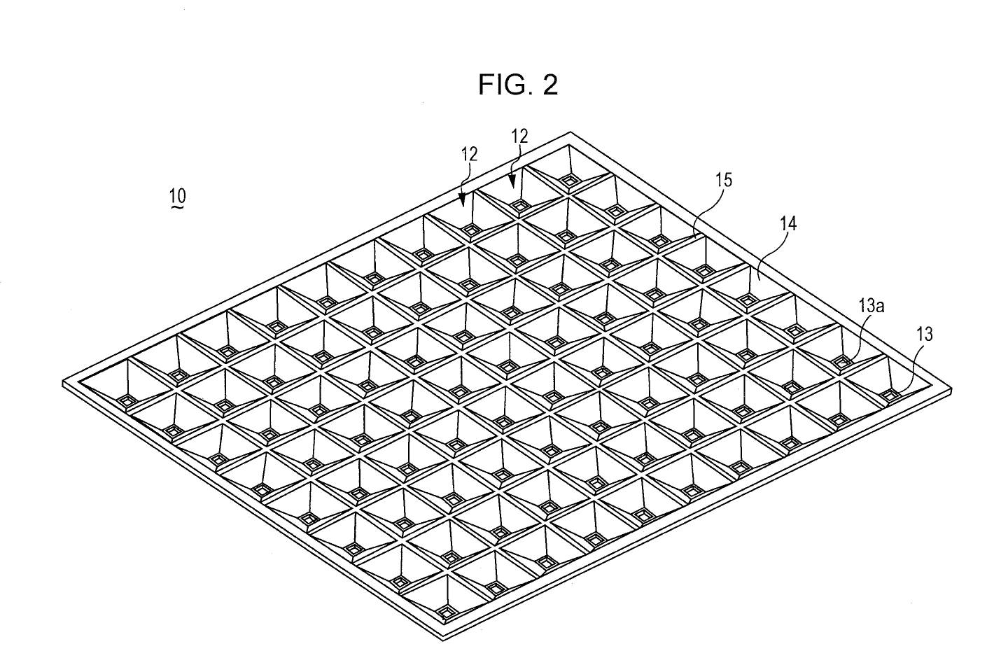

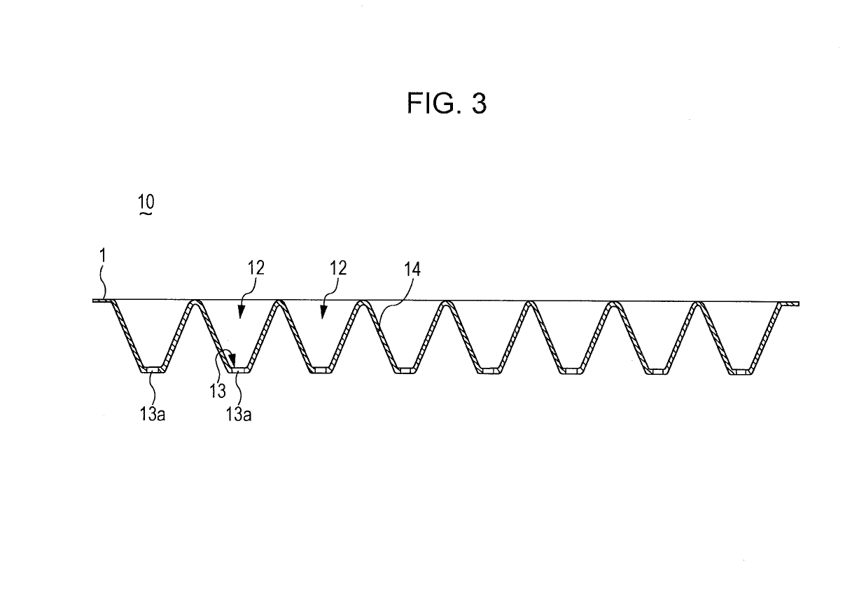

When the light reflection plate is used in illuminating apparatuses for advertisements and signboards, the light reflection plate is preferably used after having been thermoformed into a desired shape. Specifically, as shown in FIGS. 2 and 3, the thermoformed light reflection plate includes a plurality of recesses 12 having an inverted truncated quadrangular pyramid shape and continuously formed in length and width directions. A through-hole 13a serving as a portion in which a light source is to be disposed is formed in an inner bottom surface 13 of each of the recesses 12. An inner peripheral surface 14 of each of the recesses 12 is formed as a light reflection surface that reflects light emitted from the light source.

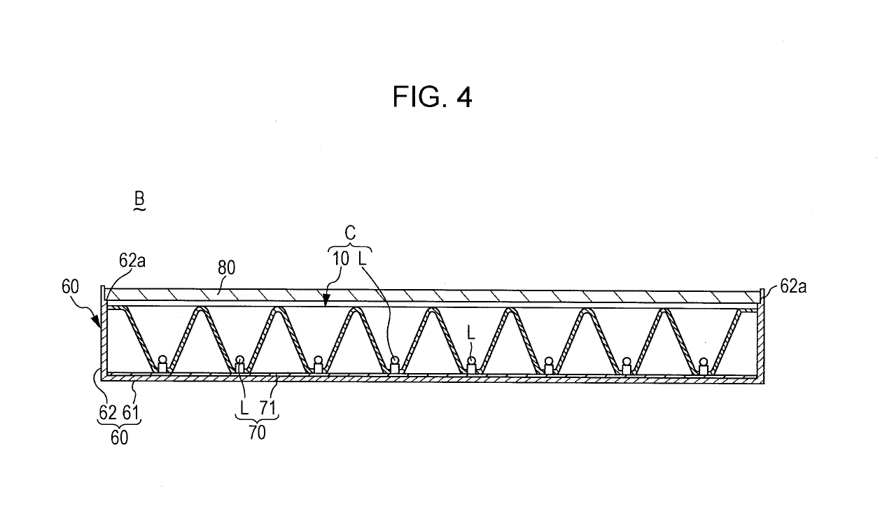

FIG. 4 shows an illuminating apparatus that uses the light reflection plate which has been thermoformed as described above. As shown in FIG. 4, the illuminating apparatus has a structure in which an illuminating body C including a light reflection plate 10 and light-emitting diodes L is disposed in a casing 60. The casing 60 includes a planar rectangular bottom portion 61 having a size larger than that of the light reflection plate 10 and a surrounding wall portion 62 having a quadrilateral frame shape and disposed so as to extend upward from four peripheral edges of the bottom portion 61. A step portion 62a is formed at the top end of an inner peripheral surface of the surrounding wall portion 62 along the entire circumference thereof. A frosted glass or an optical sheet 80 is detachably attached to the step portion 62a. The light source of the illuminating body C may be a generally used light source instead of a light-emitting diode.

There is also prepared a light source body 70 in which a large number of light-emitting diodes L are disposed on a planar square substrate 71 having such a size that the substrate 71 can be disposed on the bottom portion 61 of the casing 60. When the light reflection plate 10 is superimposed on the light source body 70, the positions of the through-holes 13a of the recesses 12 match the positions of the light-emitting diodes L on the light source body 70.

The light source body 70 is disposed on the bottom portion 61 of the casing 60 while the light-emitting diodes L face upward (in a direction toward the opening of the casing 60). The light reflection plate 10 is disposed on the light source body 70 so that the light-emitting diodes L of the light source body 70 are disposed through the through-holes 13a of the recesses 12 of the light reflection plate 10. Thus, an illuminating body C is formed.

When the illuminating apparatus B is used, the frosted glass or optical sheet 80 is detachably attached to the step portion 62a of the surrounding wall portion 62 of the casing 60 and then the light-emitting diodes L are caused to emit light (refer to FIG. 4). The light is emitted from each of the light-emitting diodes L in a radial manner and light incident upon the inner peripheral surface of each of the recesses 12 of the light reflection plate 10 is reflected at the inner peripheral surface once or multiple times so as to travel in a direction toward the frosted glass or optical sheet 80. Consequently, the light enters the frosted glass or optical sheet 80. The light reflection plate 10 of the illuminating body C is preferably not in intimate contact with the frosted glass or optical sheet 80.

The optical sheet 80 contains a light diffusing agent for diffusing light, such as titanium oxide. The light that enters the optical sheet 80 undergoes diffuse reflection by the light diffusing agent in the optical sheet 80 and is further diffused. Alternatively, the light that enters the frosted glass undergoes diffuse reflection and is further diffused. The light is then released to the outside from the frosted glass or optical sheet 80. When the frosted glass or optical sheet 80 is viewed from the front, the entire surface of the frosted glass or optical sheet 80 is substantially uniformly shining.

The light that enters the frosted glass or optical sheet 80 undergoes diffuse reflection in the frosted glass or optical sheet 80. Part of the light is reflected in a direction toward the light reflection plate A and enters the light reflection plate A direction again. The light that enters the light reflection plate 10 again is reflected at the inner peripheral surface of each of the recesses 12 and enters the frosted glass or optical sheet 80 again.

As described above, the light emitted from the light-emitting diodes L is reflected at the inner peripheral surface of each of the recesses 12 in a direction toward the frosted glass or optical sheet 80 while being diffused. Therefore, the entire surface of the frosted glass or optical sheet 80 is irradiated with a substantially uniform flux of light, and thus the positions of the light-emitting diodes are hardly recognized visually through the frosted glass or optical sheet 80.

Patterns and characters directly drawn on the frosted glass or optical sheet 80 or patterns and characters drawn on a decorative sheet disposed on the frosted glass or optical sheet 80 clearly and uniformly emerge by light uniformly emitted from the entire frosted glass or optical sheet 80. Accordingly, the illuminating apparatus described above can be appropriately used as an illuminating apparatus for advertisements and signboards.

### EXAMPLES

The present invention will now be more specifically described based on Examples, but is not limited thereto.

### Example 1

A coated titanium oxide A (trade name “CR-93” manufactured by ISHIHARA SANGYO KAISHA, LTD., average particle size: 0.28 μm) was prepared. In the coated titanium oxide A, a surface of rutile-type titanium oxide was coated with a coating layer containing aluminum oxide and silicon oxide. The amount of the aluminum oxide in the coated titanium oxide A was quantitatively determined by X-ray fluorescence analysis. The amount was 3.1% by weight in terms of Al₂O₃ relative to the total weight of titanium dioxide. The amount of the silicon oxide in the coated titanium oxide A was also quantitatively determined by X-ray fluorescence analysis. The amount was 4.2% by weight in terms of SiO₂ relative to the total weight of titanium dioxide.

The coated titanium oxide A was dried by performing heating at 100° C. for 5 hours to decrease the amount of water of hydration contained in the coated titanium oxide. Then, 53.8 parts by weight of the coated titanium oxide A in which the amount of water of hydration was decreased and 40 parts by weight of homopolypropylene (trade name “PL 500A” manufactured by SunAllomer Ltd., melt flow rate: 3.3 g/10 min, density: 0.9 g/cm³) were melt-kneaded at 230° C. in a vent-type double-screw extruder with a diameter of 120 mm to form a pellet. Thus, a master batch of the coated titanium oxide A was prepared. Herein, when the coated titanium oxide A and the homopolypropylene were melt-kneaded in a cylinder of the vent-type double-screw extruder, a gas located in the cylinder was discharged to the outside through a vent using a vacuum pump so that the pressure in the cylinder was 60 mmHg (8 kPa).

Subsequently, 93.8 parts by weight of the master batch, 60 parts by weight of homopolypropylene (trade name “PL 500A” manufactured by SunAllomer Ltd., melt flow rate: 3.3 g/10 min, density: 0.9 g/cm³), 0.15 parts by weight of a phenol-based antioxidant (trade name IRGANOX (registered trademark) 1010 manufactured by BASF), 0.15 parts by weight of a phosphorus-based antioxidant (trade name IRGAFOS 168 manufactured by BASF), 0.15 parts by weight of a benzotriazole-based ultraviolet absorber 1 (molecular weight 315.8, trade name TINUVIN (registered trademark) 326 manufactured by BASF), and 0.15 parts by weight of a hindered amine-based light stabilizer (trade name TINUVIN (registered trademark) 111 manufactured by BASF) were supplied to a vent-type single-screw extruder with a diameter of 120 mm and melt-kneaded at 220° C. to obtain a resin composition for forming light reflection plates. The resin composition for forming light reflection plates was extruded into a sheet through a T-die (sheet width: 1000 mm, distance between slits: 0.2 mm, temperature: 200° C.) attached to the head of the extruder to produce a non-foamed light reflection plate having a thickness of 0.2 mm and a density of 1.3 g/cm³. Herein, when the resin composition for forming light reflection plates was melt-kneaded in a cylinder of the vent-type single-screw extruder, a gas located in the cylinder was discharged to the outside through a vent using a vacuum pump so that the pressure in the cylinder was 60 mmHg (8 kPa).

### Example 2

A light reflection plate was produced in the same manner as in Example 1, except that a coated titanium oxide B (trade name “CR-90” manufactured by ISHIHARA SANGYO KAISHA, LTD., average particle size: 0.25 μm) was used instead of the coated titanium oxide A.

In the coated titanium oxide B, a surface of rutile-type titanium oxide was coated with a coating layer containing aluminum oxide and silicon oxide. The amount of the aluminum oxide in the coated titanium oxide B was quantitatively determined by X-ray fluorescence analysis. The amount was 2.7% by weight in terms of Al₂O₃ relative to the total weight of titanium dioxide. The amount of the silicon oxide in the coated titanium oxide B was also quantitatively determined by X-ray fluorescence analysis. The amount was 3.6% by weight in terms of SiO₂ relative to the total weight of titanium dioxide.

### Example 3

A light reflection plate was produced in the same manner as in Example 1, except that a coated titanium oxide C (trade name “CR-80” manufactured by ISHIHARA SANGYO KAISHA, LTD., average particle size: 0.25 μm) was used instead of the coated titanium oxide A.

In the coated titanium oxide C, a surface of rutile-type titanium oxide was coated with a coating layer containing aluminum oxide and silicon oxide. The amount of the aluminum oxide in the coated titanium oxide C was quantitatively determined by X-ray fluorescence analysis. The amount was 3.3% by weight in terms of Al₂O₃ relative to the total weight of titanium dioxide. The amount of the silicon oxide in the coated titanium oxide C was also quantitatively determined by X-ray fluorescence analysis. The amount was 1.8% by weight in terms of SiO₂ relative to the total weight of titanium dioxide.

### Example 4

A light reflection plate was produced in the same manner as in Example 1, except that a coated titanium oxide D (trade name “CR-63” manufactured by ISHIHARA SANGYO KAISHA, LTD., average particle size: 0.21 μm) was used instead of the coated titanium oxide A.

In the coated titanium oxide D, a surface of rutile-type titanium oxide was coated with a coating layer containing aluminum oxide and silicon oxide. The amount of the aluminum oxide in the coated titanium oxide D was quantitatively determined by X-ray fluorescence analysis. The amount was 1.4% by weight in terms of Al₂O₃ relative to the total weight of titanium dioxide. The amount of the silicon oxide in the coated titanium oxide D was also quantitatively determined by X-ray fluorescence analysis. The amount was 0.7% by weight in terms of SiO₂ relative to the total weight of titanium dioxide.

### Example 5

A light reflection plate was produced in the same manner as in Example 1, except that a coated titanium oxide E (trade name “CR-50” manufactured by ISHIHARA SANGYO KAISHA, LTD., average particle size: 0.25 μm) was used instead of the coated titanium oxide A.

In the coated titanium oxide E, a surface of rutile-type titanium oxide was coated with a coating layer containing aluminum oxide and silicon oxide. The amount of the aluminum oxide in the coated titanium oxide E was quantitatively determined by X-ray fluorescence analysis. The amount was 2.3% by weight in terms of Al₂O₃ relative to the total weight of titanium dioxide. The amount of the silicon oxide in the coated titanium oxide E was also quantitatively determined by X-ray fluorescence analysis. The amount was 0.1% by weight in terms of SiO₂ relative to the total weight of titanium dioxide.

### Examples 6 to 10

A light reflection plate was produced in the same manner as in Example 1, except that the type of coated titanium oxide was changed as shown in Table 1 and furthermore a benzotriazole-based ultraviolet absorber 2 (molecular weight 447.6, trade name TINUVIN (registered trademark) 234 manufactured by BASF) was used instead of the benzotriazole-based ultraviolet absorber 1.

### Examples 11 and 12

A light reflection plate was produced in the same manner as in Example 1, except that the amount of coated titanium oxide added was changed as shown in Table 1 and furthermore a benzotriazole-based ultraviolet absorber 2 (molecular weight 447.6, trade name TINUVIN (registered trademark) 234 manufactured by BASF) was used instead of the benzotriazole-based ultraviolet absorber 1.

### Comparative Examples 1 to 4

A light reflection plate was produced in the same manner as in Example 1, except that the type of coated titanium oxide was changed as shown in Table 1 and the drying by heating of the coated titanium oxide was not performed.

### Comparative Examples 5 and 6

A light reflection plate was produced in the same manner as in Example 1, except that the amount of coated titanium oxide added was changed as shown in Table 1, the drying by heating of the coated titanium oxide was not performed, and a benzotriazole-based ultraviolet absorber 2 (molecular weight 447.6, trade name TINUVIN (registered trademark) 234 manufactured by BASF) was used instead of the benzotriazole-based ultraviolet absorber 1.

### Example 13

A coated titanium oxide A (trade name “CR-93” manufactured by ISHIHARA SANGYO KAISHA, LTD., average particle size: 0.28 μm) was prepared. In the coated titanium oxide A, a surface of rutile-type titanium oxide was coated with a coating layer containing aluminum oxide and silicon oxide. The amount of the aluminum oxide in the coated titanium oxide A was quantitatively determined by X-ray fluorescence analysis. The amount was 3.1% by weight in terms of Al₂O₃ relative to the total weight of titanium dioxide. The amount of the silicon oxide in the coated titanium oxide A was also quantitatively determined by X-ray fluorescence analysis. The amount was 4.2% by weight in terms of SiO₂ relative to the total weight of titanium dioxide.

The coated titanium oxide A was dried by performing heating at 100° C. for 5 hours to decrease the amount of water of hydration contained in the coated titanium oxide. Then, 53.8 parts by weight of the coated titanium oxide A in which the amount of water of hydration was decreased and 40 parts by weight of homopolypropylene (trade name “PL 500A” manufactured by SunAllomer Ltd., melt flow rate: 3.3 g/10 min, density: 0.9 g/cm³) were melt-kneaded at 230° C. in a vent-type double-screw extruder with a diameter of 120 mm to form a pellet. Thus, a master batch of the coated titanium oxide A was prepared. Herein, when the coated titanium oxide A and the homopolypropylene were melt-kneaded in a cylinder of the vent-type double-screw extruder, a gas located in the cylinder was discharged to the outside through a vent using a vacuum pump so that the pressure in the cylinder was 60 mmHg (8 kPa).

Subsequently, 93.8 parts by weight of the master batch, 60 parts by weight of homopolypropylene (trade name “PL 500A” manufactured by SunAllomer Ltd., melt flow rate: 3.3 g/10 min, density: 0.9 g/cm³), 0.15 parts by weight of a phenol-based antioxidant (trade name IRGANOX (registered trademark) 1010 manufactured by BASF), 0.15 parts by weight of a phosphorus-based antioxidant (trade name IRGAFOS 168 manufactured by BASF), 0.15 parts by weight of a benzotriazole-based ultraviolet absorber 1 (molecular weight 315.8, trade name TINUVIN (registered trademark) 326 manufactured by BASF), and 0.15 parts by weight of a hindered amine-based light stabilizer (trade name TINUVIN (registered trademark) 111 manufactured by BASF) were supplied to a vent-type single-screw extruder with a diameter of 120 mm and melt-kneaded at 220° C. to obtain a resin composition for forming light reflection plates. The resin composition for forming light reflection plates was extruded into a strand through a nozzle die attached to the head of the vent-type single-screw extruder. The strand was cut so as to have a length of 2.5 mm and formed so as to have a cylindrical shape having a diameter of 2.5 mm. Thus, a resin composition for forming light reflection plates in the form of a pellet was obtained. Herein, when the resin composition for forming light reflection plates was melt-kneaded in a cylinder of the vent-type single-screw extruder, a gas located in the cylinder was discharged to the outside through a vent using a vacuum pump so that the pressure in the cylinder was 60 mmHg (8 kPa).

The resin composition for forming light reflection plates in the form of a pellet was supplied to a vent-type single-screw extruder with a diameter of 120 mm and melt-kneaded at 220° C. The resin composition for forming light reflection plates was extruded into a sheet through a T-die (sheet width: 1000 mm, distance between slits: 0.2 mm, temperature: 200° C.) attached to the head of the extruder to produce a non-foamed light reflection plate having a thickness of 0.2 mm and a density of 1.3 g/cm³. Herein, when the resin composition for forming light reflection plates was melt-kneaded in a cylinder of the vent-type single-screw extruder, a gas located in the cylinder was discharged to the outside through a vent using a vacuum pump so that the pressure in the cylinder was 60 mmHg (8 kPa).

### Example 14

A light reflection plate was produced in the same manner as in Example 13, except that a coated titanium oxide B (trade name “CR-90” manufactured by ISHIHARA SANGYO KAISHA, LTD., average particle size: 0.25 μm) was used instead of the coated titanium oxide A.

In the coated titanium oxide B, a surface of rutile-type titanium oxide was coated with a coating layer containing aluminum oxide and silicon oxide. The amount of the aluminum oxide in the coated titanium oxide B was quantitatively determined by X-ray fluorescence analysis. The amount was 2.7% by weight in terms of Al₂O₃ relative to the total weight of titanium dioxide. The amount of the silicon oxide in the coated titanium oxide B was also quantitatively determined by X-ray fluorescence analysis. The amount was 3.6% by weight in terms of SiO₂ relative to the total weight of titanium dioxide.

### Example 15

A light reflection plate was produced in the same manner as in Example 13, except that a coated titanium oxide C (trade name “CR-80” manufactured by ISHIHARA SANGYO KAISHA, LTD., average particle size: 0.25 μm) was used instead of the coated titanium oxide A.

In the coated titanium oxide C, a surface of rutile-type titanium oxide was coated with a coating layer containing aluminum oxide and silicon oxide. The amount of the aluminum oxide in the coated titanium oxide C was quantitatively determined by X-ray fluorescence analysis. The amount was 3.3% by weight in terms of Al₂O₃ relative to the total weight of titanium dioxide. The amount of the silicon oxide in the coated titanium oxide C was also quantitatively determined by X-ray fluorescence analysis. The amount was 1.8% by weight in terms of SiO₂ relative to the total weight of titanium dioxide.

### Example 16

A light reflection plate was produced in the same manner as in Example 13, except that a coated titanium oxide D (trade name “CR-63” manufactured by ISHIHARA SANGYO KAISHA, LTD., average particle size: 0.21 μm) was used instead of the coated titanium oxide A.

In the coated titanium oxide D, a surface of rutile-type titanium oxide was coated with a coating layer containing aluminum oxide and silicon oxide. The amount of the aluminum oxide in the coated titanium oxide D was quantitatively determined by X-ray fluorescence analysis. The amount was 1.4% by weight in terms of Al₂O₃ relative to the total weight of titanium dioxide. The amount of the silicon oxide in the coated titanium oxide D was also quantitatively determined by X-ray fluorescence analysis. The amount was 0.7% by weight in terms of SiO₂ relative to the total weight of titanium dioxide.

### Example 17

A light reflection plate was produced in the same manner as in Example 13, except that a coated titanium oxide E (trade name “CR-50” manufactured by ISHIHARA SANGYO KAISHA, LTD., average particle size: 0.25 μm) was used instead of the coated titanium oxide A.

In the coated titanium oxide E, a surface of rutile-type titanium oxide was coated with a coating layer containing aluminum oxide and silicon oxide. The amount of the aluminum oxide in the coated titanium oxide E was quantitatively determined by X-ray fluorescence analysis. The amount was 2.3% by weight in terms of Al₂O₃ relative to the total weight of titanium dioxide. The amount of the silicon oxide in the coated titanium oxide E was also quantitatively determined by X-ray fluorescence analysis. The amount was 0.1% by weight in terms of SiO₂ relative to the total weight of titanium dioxide.

### Examples 18 to 22

A light reflection plate was produced in the same manner as in Example 13, except that the type of coated titanium oxide was changed as shown in Table 1 and furthermore a benzotriazole-based ultraviolet absorber 2 (molecular weight 447.6, trade name TINUVIN (registered trademark) 234 manufactured by BASF) was used instead of the benzotriazole-based ultraviolet absorber 1.

### Examples 23 and 24

A light reflection plate was produced in the same manner as in Example 13, except that the amount of coated titanium oxide added was changed as shown in Table 1 and furthermore a benzotriazole-based ultraviolet absorber 2 (molecular weight 447.6, trade name TINUVIN (registered trademark) 234 manufactured by BASF) was used instead of the benzotriazole-based ultraviolet absorber 1.

### Comparative Examples 7 to 10

A light reflection plate was produced in the same manner as in Example 13, except that the type of coated titanium oxide was changed as shown in Table 1 and the drying by heating of the coated titanium oxide was not performed.

### Comparative Examples 11 and 12

A light reflection plate was produced in the same manner as in Example 13, except that the amount of coated titanium oxide added was changed as shown in Table 1, the drying by heating of the coated titanium oxide was not performed, and a benzotriazole-based ultraviolet absorber 2 (molecular weight 447.6, trade name TINUVIN (registered trademark) 234 manufactured by BASF) was used instead of the benzotriazole-based ultraviolet absorber 1.

### (Evaluation)

In a cross section of the light reflection plate in a thickness direction, the particle size and number of unagglomerated primary particles of the coated titanium oxide and the particle size and number of agglomerated particles of the coated titanium oxide were measured by the above-described method. The measurement was conducted in ten measurement regions (each having a square shape with 30 μm sides) arbitrarily selected from the cross section of the light reflection plate in the thickness direction. Table 1 shows the results.

Regarding the particle size of the primary particles of the coated titanium oxide, Table 1 shows the maximum particle size and minimum particle size of the primary particles of the coated titanium oxide contained in the ten measurement regions. Regarding the particle size of the agglomerated particles of the coated titanium oxide, Table 1 shows the maximum particle size and minimum particle size of the agglomerated particles of the coated titanium oxide contained in the ten measurement regions. The number of the unagglomerated primary particles of the coated titanium oxide and the number of the agglomerated particles of the coated titanium oxide were each measured in the ten measurement regions, and Table 1 shows the arithmetic mean of each of the numbers.

The moisture content of the coated titanium oxide contained in the light reflection plate, the surface smoothness of the light reflection plate, the formability of the light reflection plate, and the light reflectances of the light reflection plate before and after a weather resistance test were evaluated by the following methods. Tables 1 and 2 show the results.

### (Moisture Content: Light Reflection Plate)

The components other than the coated titanium oxide, such as the polyolefin-based resin, antioxidants, ultraviolet absorber, and light stabilizer used in the light reflection plate do not have water absorbency and thus cannot contain water, and only the coating layer of the coated titanium oxide contained in the light reflection plate can contain water. Therefore, all the water contained in the light reflection plate can be assumed to be contained in the coating layer of the coated titanium oxide. Furthermore, since the coated titanium oxide contained in the light reflection plate is dispersed in the polyolefin-based resin, there are almost no particles, of the coated titanium oxide contained in the light reflection plate, whose surfaces are exposed without being coated with the polyolefin-based resin, and thus the surface of the coated titanium oxide is coated with the polyolefin-based resin having no water absorbency. Therefore, even if the light reflection plate is left to stand for a long time, the moisture content of the coated titanium oxide substantially does not change and is kept at a constant value.

In the present invention, the light reflection plate is cut into test pieces having a predetermined size so as to have a weight of 5 g. The amount (W₁ [g]) of water in each of the test pieces is measured by the process below, and this amount of water in the test piece is regarded as the amount of water of the coated titanium oxide in the test piece. Subsequently, the weight (W₂ [g]) of the coated titanium oxide contained in the test piece is measured by the process below, and a value calculated from formula: W₁/(W₁+W₂)×100 is defined as the moisture content (% by weight) of the coated titanium oxide contained in the test piece. Thirty test pieces were prepared from the light reflection plate and the moisture content of the coated titanium oxide is measured for each of the test pieces. The arithmetic mean of the moisture contents is defined as the moisture content of the coated titanium oxide contained in the light reflection plate.

In the measurement of the amount of water in the test piece, the test piece is left to stand at 25° C. and 30% RH for one hour and then the water contained in the test piece is vaporized using a water vaporizer under the following conditions. The amount [g] of the vaporized water is measured using a Karl Fischer moisture meter conforming to a method for measuring moisture of chemical products in JIS K 0068.

Equipment: Water vaporizer (ADP-511 manufactured by Kyoto Electronics Manufacturing Co., Ltd.)

MKC-510N manufactured by Kyoto Electronics Manufacturing Co., Ltd.

Vaporization temperature: 230° C.

Carrier gas: N₂, 200 ml/min

Time for measuring amount of water: 30 minutes

In the measurement of the weight of the coated titanium oxide contained in the test piece, the test piece is ashed by being baked using an electric furnace (e.g., Muffle furnace STR-15K manufactured by ISUZU) at 550° C. for one hour to obtain an ash, and the weight [g] of the ash is measured using a measuring instrument (e.g., Precision analytical electronic balance HA-202M manufactured by A&D Company, Limited). The measured weight is regarded as the weight of the coated titanium oxide contained in the test piece.

### (Moisture Content: Resin Composition for Forming Light Reflection Plates)

The moisture content of the coated titanium oxide contained in each of the resin compositions for forming light reflection plates produced in the form of a pellet in Examples 13 to 24 and Comparative Examples 7 to 12 was also measured. The moisture content of the coated titanium oxide contained in the resin composition for forming light reflection plates can be measured in the same manner as the moisture content of the coated titanium oxide contained in the light reflection plate, except that a sample prepared by weighing 5 g of the resin composition for forming light reflection plates is used instead of 5 g of the test piece prepared by cutting the light reflection plate. In all of Comparative Examples and Examples, the moisture content of the coated titanium oxide contained in the resin composition for forming light reflection plates produced in the form of a pellet was equal to the moisture content of the coated titanium oxide contained in the light reflection plate.

### (Surface Smoothness)

The surface smoothness of the light reflection plate was evaluated through visual inspection. In Tables 1 and 2, the criteria of “Excellent”, “Good”, and “Bad” are as follows.

Excellent: There were no portions in which a projection or a through-hole extending between both surfaces of a light reflection plate was formed in the light reflection plate.

Good: There were one to three portions in which a projection or a through-hole extending between both surfaces of a light reflection plate was formed in the light reflection plate.

Bad: There were more than three portions in which a projection or a through-hole extending between both surfaces of a light reflection plate was formed in the light reflection plate.

The projection formed in the light reflection plate means a projection with a height of 0.01 mm or more that protrudes from the surface of the light reflection plate as a result of the foaming due to moisture or the like present in the light reflection plate.

### (Formability)

The light reflection plate was thermoformed by the following method. The light reflection plate was cut into pieces each having a planar square shape with 64 cm sides. Each of the pieces was heated in a heating furnace at 350° C. so that the surface of the piece had a temperature of 170° C. Subsequently, recesses 12 having an inverted truncated quadrangular pyramid shape were formed by causing a portion other than the four peripheral edges to bulge from the front surface side to the back surface side by matched mold forming, and then cutting was performed at a predetermined position. In the thus-thermoformed light reflection plate, 96 recesses 12 were continuously formed on substantially the entire surface in the length and width directions. The thermoformed light reflection plate had a planar rectangular shape (A3 size) with a length of 42 cm and a width of 29.7 cm. Note that twelve recesses 12 were formed along the long side and eight recesses 12 were formed along the short side.

Each of the recesses 12 of the light reflection plate 10 included a planar square bottom portion 13 with 0.6 cm sides and a surrounding wall portion 14 disposed so as to extend from the four peripheral edges of the bottom portion 13 while gradually expanding toward the front surface. The entire inner peripheral surface of the surrounding wall portion 14 was formed as a light reflection surface. Adjacent recesses 12 were integrally formed through a connecting portion 15 formed in a grid-like manner at their open ends. The open end of the surrounding wall portion 14 had a planar rectangular shape with a length of 3.2 cm and a width of 3.5 cm. The height of the connecting portion 15 from the inner surface of the bottom portion 13 was 1.6 cm. Furthermore, a planar square through-hole 13a with 0.54 cm sides was made in the bottom portion 13 of each of the recesses 12 so as to extend between the front surface and the back surface.

By the above method, 100 light reflection plates were thermoformed. The surface state of each of the thermoformed light reflection plates was visually inspected to evaluate the formability of the light reflection plate on the basis of the following criteria. In Tables 1 and 2, the criteria of “Excellent”, “Good”, and “Bad” are as follows.

Excellent: Among 100 thermoformed light reflection plates, there were less than three light reflection plates having surfaces on which uneven gloss or roughness was caused.

Good: Among 100 thermoformed light reflection plates, there were three to ten light reflection plates having surfaces on which uneven gloss or roughness was caused.

Bad: Among 100 thermoformed light reflection plates, there were more than ten light reflection plates having surfaces on which uneven gloss or roughness was caused.

When it was visually confirmed that a portion having a low degree of gloss was locally formed on the surface of the thermoformed light reflection plate, it was evaluated that “uneven gloss” was caused on the surface of the thermoformed light reflection plate. Furthermore, when a projection with a height of 0.01 mm or more that protruded from the surface of the light reflection plate as a result of the foaming due to moisture or the like present in the light reflection plate, a local recess, or a crack was formed on the surface of the thermoformed light reflection plate, it was evaluated that “roughness” was caused on the surface of the thermoformed light reflection plate.

### (Weather Resistance Test)

A test piece having a length of 50 mm and a width of 150 mm was cut from the light reflection plate. The test piece was subjected to an accelerated exposure test under the following conditions in conformity with JIS A 1415 (Accelerated exposure test method for plastic building materials).

Irradiation equipment: trade name “Sunshine Super Long Life Weather Meter WEL-SUN-HC B type” manufactured by Suga Test Instruments Co., Ltd.

Irradiation conditions: Back panel temperature: 60° C. to 70° C., Spraying: no, Chamber temperature: 45° C. to 55° C., Relative humidity: 10% to 30%

### (Light Reflectance)

The light reflectances of a test piece before the accelerated exposure test, 500 hours after the accelerated exposure test, and 1000 hours after the accelerated exposure test were measured by the method below. Note that 30 test pieces were prepared, and the arithmetic mean of the light reflectances of the test pieces was defined as the light reflectance.

The light reflectance of the test piece is a light reflectance at a wavelength of 550 nm in the case where the total reflection measurement was conducted at an incident angle of 8° in conformity with the Measurement method B described in JIS K 7105. The light reflectance is an absolute value obtained when the light reflectance measured using a barium sulfate plate as a reference reflection plate is assumed to be 100.

Specifically, the light reflectance of the test piece can be measured by combining an ultraviolet-visible spectrometer “UV-2450” (trade name) commercially available from SHIMADZU CORPORATION with an integrating sphere attachment “ISR-2200” (trade name, internal diameter: φ60 mm) commercially available from SHIMADZU CORPORATION.

TABLE 1

| | | | Example | | | | | | | | |
|---|---|---|---|---|---|---|---|---|---|---|---|
| | | | 1 | 2 | 3 | 4 | 5 | 6 | 7 | 8 | 9 |
| Blend | Polypropylene | | 100 | 100 | 100 | 100 | 100 | 100 | 100 | 100 | 100 |
| composition | Coated titanium oxide | | 53.8 | 53.8 | 53.8 | 53.8 | 53.8 | 53.8 | 53.8 | 53.8 | 53.8 |
| [parts by | Phenol-based antioxidant | | 0.15 | 0.15 | 0.15 | 0.15 | 0.15 | 0.15 | 0.15 | 0.15 | 0.15 |
| weight] | Phosphorus-based antioxidant | | 0.15 | 0.15 | 0.15 | 0.15 | 0.15 | 0.15 | 0.15 | 0.15 | 0.15 |
| | Ultraviolet absorber 1 | | 0.15 | 0.15 | 0.15 | 0.15 | 0.15 | 0 | 0 | 0 | 0 |
| | Ultraviolet absorber 2 | | 0 | 0 | 0 | 0 | 0 | 0.15 | 0.15 | 0.15 | 0.15 |
| | Hindered amine-based light stabilizer | | 0.15 | 0.15 | 0.15 | 0.15 | 0.15 | 0.15 | 0.15 | 0.15 | 0.15 |
| Coated | Type of coated titanium oxide | | A | B | C | D | E | A | B | C | D |
| titanium | Composition | Titanium dioxide | 100 | 100 | 100 | 100 | 100 | 100 | 100 | 100 | 100 |
| oxide | analysis | Aluminum oxide | 3.1 | 2.7 | 3.3 | 1.4 | 2.3 | 3.1 | 2.7 | 3.3 | 1.4 |
| | [% by weight] | Silicon oxide | 4.2 | 3.6 | 1.8 | 0.7 | 0.1 | 4.2 | 3.6 | 1.8 | 0.7 |
| | Moisture content (% by weight) | | 0.37 | 0.34 | 0.34 | 0.29 | 0.29 | 0.37 | 0.34 | 0.34 | 0.29 |
| Coated | Primary particles | Maximum particle size [μm] | 0.39 | 0.38 | 0.38 | 0.37 | 0.37 | 0.39 | 0.38 | 0.38 | 0.37 |
| titanium | | Minimum particle size [μm] | 0.14 | 0.13 | 0.13 | 0.13 | 0.13 | 0.14 | 0.13 | 0.13 | 0.13 |
| oxide in | | Number [/900 μm²] | 325 | 286 | 286 | 266 | 286 | 325 | 286 | 286 | 266 |
| light | Agglomerated | Maximum particle size [μm] | 1.12 | 1.06 | 1.06 | 0.99 | 1.06 | 1.12 | 1.06 | 1.06 | 0.99 |
| reflection | particles | Minimum particle size [μm] | 0.45 | 0.43 | 0.43 | 0.40 | 0.43 | 0.45 | 0.43 | 0.43 | 0.40 |
| plate | | Number [/900 μm²] | 91 | 101 | 101 | 107 | 101 | 91 | 101 | 101 | 107 |
| Surface smoothness | | | G | G | G | G | G | Ex | Ex | Ex | Ex |
| Formability | | | G | G | G | G | G | Ex | Ex | Ex | Ex |
| Light | Weather | Before test | 98.6 | 98.6 | 98.6 | 98.6 | 98.6 | 98.6 | 98.6 | 98.6 | 98.6 |
| reflectance | resistance | | | | | | | | | | |
| [%] | Accelerated | After test | 98.3 | 98.3 | 98.3 | 97.6 | 97.6 | 98.3 | 98.3 | 98.3 | 97.6 |
| | exposure 500 | Difference between before | −0.3 | −0.3 | −0.3 | −1.0 | −1.0 | −0.3 | −0.3 | −0.3 | −1.0 |
| | hours | and after test | | | | | | | | | |
| | Accelerated | After test | 97.8 | 97.8 | 97.8 | 96.6 | 96.6 | 97.8 | 97.8 | 97.8 | 96.6 |
| | exposure 1000 | Difference between before | −0.8 | −0.8 | −0.8 | −2.0 | −2.0 | −0.8 | −0.8 | −0.8 | −2.0 |
| | hours | and after test | | | | | | | | | |
| | | | Example | | | Comparative Example | | | | | |
| | | | 10 | 11 | 12 | 1 | 2 | 3 | 4 | 5 | 6 |
| Blend | Polypropylene | | 100 | 100 | 100 | 100 | 100 | 100 | 100 | 100 | 100 |
| composition | Coated titanium oxide | | 53.8 | 33.3 | 100 | 53.8 | 53.8 | 53.8 | 53.8 | 33.3 | 100 |
| [parts by | Phenol-based antioxidant | | 0.15 | 0.15 | 0.15 | 0.15 | 0.15 | 0.15 | 0.15 | 0.15 | 0.15 |
| weight] | Phosphorus-based antioxidant | | 0.15 | 0.15 | 0.15 | 0.15 | 0.15 | 0.15 | 0.15 | 0.15 | 0.15 |
| | Ultraviolet absorber 1 | | 0 | 0 | 0 | 0.15 | 0.15 | 0.15 | 0.15 | 0 | 0 |
| | Ultraviolet absorber 2 | | 0.15 | 0.15 | 0.15 | 0 | 0 | 0 | 0 | 0.15 | 0.15 |
| | Hindered amine-based light stabilizer | | 0.15 | 0.15 | 0.15 | 0.15 | 0.15 | 0.15 | 0.15 | 0.15 | 0.15 |
| Coated | Type of coated titanium oxide | | E | A | A | A | C | D | E | A | A |
| titanium | Composition | Titanium dioxide | 100 | 100 | 100 | 100 | 100 | 100 | 100 | 100 | 100 |
| oxide | analysis | Aluminum oxide | 2.3 | 3.1 | 3.1 | 3.1 | 3.3 | 1.4 | 2.3 | 3.1 | 3.1 |
| | [% by weight] | Silicon oxide | 0.1 | 4.2 | 4.2 | 4.2 | 1.8 | 0.7 | 0.1 | 4.2 | 4.2 |
| | Moisture content (% by weight) | | 0.29 | 0.37 | 0.37 | 0.86 | 0.66 | 0.52 | 0.55 | 0.86 | 0.86 |
| Coated | Primary particles | Maximum particle size [μm] | 0.37 | 0.39 | 0.39 | 0.39 | 0.38 | 0.37 | 0.37 | 0.39 | 0.39 |
| titanium | | Minimum particle size [μm] | 0.13 | 0.14 | 0.14 | 0.14 | 0.13 | 0.13 | 0.13 | 0.14 | 0.14 |
| oxide in | | Number [/900 μm²] | 286 | 232 | 464 | 105 | 147 | 109 | 147 | 104 | 111 |
| light | Agglomerated | Maximum particle size [μm] | 1.06 | 1.12 | 1.12 | 1.43 | 1.37 | 1.32 | 1.37 | 1.43 | 1.43 |
| reflection | particles | Minimum particle size [μm] | 0.43 | 0.45 | 0.45 | 0.69 | 0.67 | 0.64 | 0.67 | 0.69 | 0.69 |
| plate | | Number [/900 μm²] | 101 | 64 | 129 | 146 | 136 | 121 | 136 | 96 | 218 |
| Surface smoothness | | | Ex | Ex | Ex | Ba | Ba | Ba | Ba | Ba | Ba |
| Formability | | | Ex | Ex | Ex | Ba | Ba | Ba | Ba | Ba | Ba |
| Light | Weather | Before test | 98.6 | 98.3 | 98.9 | 98.2 | 98.2 | 98.3 | 98.3 | 98.0 | 98.3 |
| reflectance | resistance | | | | | | | | | | |
| [%] | Accelerated | After test | 97.6 | 98.0 | 98.6 | 97.9 | 97.9 | 97.3 | 97.3 | 97.7 | 98.0 |
| | exposure 500 | Difference between before | −1.0 | −0.3 | −0.3 | −0.3 | −0.3 | −1.0 | −1.0 | −0.3 | −0.3 |
| | hours | and after test | | | | | | | | | |
| | Accelerated | After test | 96.6 | 97.5 | 98.1 | 97.4 | 97.4 | 96.3 | 96.3 | 97.2 | 97.5 |
| | exposure 1000 | Difference between before | −2.0 | −0.8 | −0.8 | −0.8 | −0.8 | −2.0 | −2.0 | −0.8 | −0.8 |
| | hours | and after test | | | | | | | | | |

Ex: Excellent,
G: Good,
Ba: Bad

TABLE 2

| | | | Example | | | | | | | | |
|---|---|---|---|---|---|---|---|---|---|---|---|
| | | | 13 | 14 | 15 | 16 | 17 | 18 | 19 | 20 | 21 |
| Blend | Polypropylene | | 100 | 100 | 100 | 100 | 100 | 100 | 100 | 100 | 100 |
| composition | Coated titanium oxide | | 53.8 | 53.8 | 53.8 | 53.8 | 53.8 | 53.8 | 53.8 | 53.8 | 53.8 |
| [parts by | Phenol-based antioxidant | | 0.15 | 0.15 | 0.15 | 0.15 | 0.15 | 0.15 | 0.15 | 0.15 | 0.15 |
| weight] | Phosphorus-based antioxidant | | 0.15 | 0.15 | 0.15 | 0.15 | 0.15 | 0.15 | 0.15 | 0.15 | 0.15 |
| | Ultraviolet absorber 1 | | 0.15 | 0.15 | 0.15 | 0.15 | 0.15 | 0 | 0 | 0 | 0 |
| | Ultraviolet absorber 2 | | 0 | 0 | 0 | 0 | 0 | 0.15 | 0.15 | 0.15 | 0.15 |
| | Hindered amine-based light stabilizer | | 0.15 | 0.15 | 0.15 | 0.15 | 0.15 | 0.15 | 0.15 | 0.15 | 0.15 |
| Coated | Type of coated titanium oxide | | A | B | C | D | E | A | B | C | D |
| titanium | Composition | Titanium dioxide | 100 | 100 | 100 | 100 | 100 | 100 | 100 | 100 | 100 |
| oxide | analysis | Aluminum oxide | 3.1 | 2.7 | 3.3 | 1.4 | 2.3 | 3.1 | 2.7 | 3.3 | 1.4 |
| | [% by weight] | Silicon oxide | 4.2 | 3.6 | 1.8 | 0.7 | 0.1 | 4.2 | 3.6 | 1.8 | 0.7 |
| | Moisture content (% by weight) | | 0.37 | 0.34 | 0.34 | 0.29 | 0.29 | 0.37 | 0.34 | 0.34 | 0.29 |
| Coated | Primary particles | Maximum particle size [μm] | 0.39 | 0.38 | 0.38 | 0.37 | 0.37 | 0.39 | 0.38 | 0.38 | 0.37 |
| titanium | | Minimum particle size [μm] | 0.14 | 0.13 | 0.13 | 0.13 | 0.13 | 0.14 | 0.13 | 0.13 | 0.13 |
| oxide in | | Number [/900 μm²] | 325 | 286 | 286 | 266 | 286 | 325 | 286 | 286 | 266 |
| light | Agglomerated | Maximum particle size [μm] | 1.12 | 1.06 | 1.06 | 0.99 | 1.06 | 1.12 | 1.06 | 1.06 | 0.99 |
| reflection | particles | Minimum particle size [μm] | 0.45 | 0.43 | 0.43 | 0.40 | 0.43 | 0.45 | 0.43 | 0.43 | 0.40 |
| plate | | Number [/900 μm²] | 91 | 101 | 101 | 107 | 101 | 91 | 101 | 101 | 107 |
| Surface smoothness | | | G | G | G | G | G | Ex | Ex | Ex | Ex |
| Formability | | | G | G | G | G | G | Ex | Ex | Ex | Ex |
| Light | Weather | Before test | 98.6 | 98.6 | 98.6 | 98.6 | 98.6 | 98.6 | 98.6 | 98.6 | 98.6 |
| reflectance | resistance | | | | | | | | | | |
| [%] | Accelerated | After test | 98.3 | 98.3 | 98.3 | 97.6 | 97.6 | 98.3 | 98.3 | 98.3 | 97.6 |
| | exposure 500 | Difference between before | −0.3 | −0.3 | −0.3 | −1.0 | −1.0 | −0.3 | −0.3 | −0.3 | −1.0 |
| | hours | and after test | | | | | | | | | |
| | Accelerated | After test | 97.8 | 97.8 | 97.8 | 96.6 | 96.6 | 97.8 | 97.8 | 97.8 | 96.6 |
| | exposure 1000 | Difference between before | −0.8 | −0.8 | −0.8 | −2.0 | −2.0 | −0.8 | −0.8 | −0.8 | −2.0 |
| | hours | and after test | | | | | | | | | |
| | | | Example | | | Comparative Example | | | | | |
| | | | 22 | 23 | 24 | 7 | 8 | 9 | 10 | 11 | 12 |
| Blend | Polypropylene | | 100 | 100 | 100 | 100 | 100 | 100 | 100 | 100 | 100 |
| composition | Coated titanium oxide | | 53.8 | 33.3 | 100 | 53.8 | 53.8 | 53.8 | 53.8 | 33.3 | 100 |
| [parts by | Phenol-based antioxidant | | 0.15 | 0.15 | 0.15 | 0.15 | 0.15 | 0.15 | 0.15 | 0.15 | 0.15 |
| weight] | Phosphorus-based antioxidant | | 0.15 | 0.15 | 0.15 | 0.15 | 0.15 | 0.15 | 0.15 | 0.15 | 0.15 |
| | Ultraviolet absorber 1 | | 0 | 0 | 0 | 0.15 | 0.15 | 0.15 | 0.15 | 0 | 0 |
| | Ultraviolet absorber 2 | | 0.15 | 0.15 | 0.15 | 0 | 0 | 0 | 0 | 0.15 | 0.15 |
| | Hindered amine-based light stabilizer | | 0.15 | 0.15 | 0.15 | 0.15 | 0.15 | 0.15 | 0.15 | 0.15 | 0.15 |
| Coated | Type of coated titanium oxide | | E | A | A | A | C | D | E | A | A |
| titanium | Composition | Titanium dioxide | 100 | 100 | 100 | 100 | 100 | 100 | 100 | 100 | 100 |
| oxide | analysis | Aluminum oxide | 2.3 | 3.1 | 3.1 | 3.1 | 3.3 | 1.4 | 2.3 | 3.1 | 3.1 |
| | [% by weight] | Silicon oxide | 0.1 | 4.2 | 4.2 | 4.2 | 1.8 | 0.7 | 0.1 | 4.2 | 4.2 |
| | Moisture content (% by weight) | | 0.29 | 0.37 | 0.37 | 0.86 | 0.66 | 0.52 | 0.55 | 0.86 | 0.86 |
| Coated | Primary particles | Maximum particle size [μm] | 0.37 | 0.39 | 0.39 | 0.39 | 0.38 | 0.37 | 0.37 | 0.39 | 0.39 |
| titanium | | Minimum particle size [μm] | 0.13 | 0.14 | 0.14 | 0.14 | 0.13 | 0.13 | 0.13 | 0.14 | 0.14 |
| oxide in | | Number [/900 μm²] | 286 | 232 | 464 | 105 | 147 | 109 | 147 | 104 | 111 |
| light | Agglomerated | Maximum particle size [μm] | 1.06 | 1.12 | 1.12 | 1.43 | 1.37 | 1.32 | 1.37 | 1.43 | 1.43 |
| reflection | particles | Minimum particle size [μm] | 0.43 | 0.45 | 0.45 | 0.69 | 0.67 | 0.64 | 0.67 | 0.69 | 0.69 |
| plate | | Number [/900 μm²] | 101 | 64 | 129 | 146 | 136 | 121 | 136 | 96 | 218 |
| Surface smoothness | | | Ex | Ex | Ex | Ba | Ba | Ba | Ba | Ba | Ba |
| Formability | | | Ex | Ex | Ex | Ba | Ba | Ba | Ba | Ba | Ba |
| Light | Weather | Before test | 98.6 | 98.3 | 98.9 | 98.2 | 98.2 | 98.3 | 98.3 | 98.0 | 98.3 |
| reflectance | resistance | | | | | | | | | | |
| [%] | Accelerated | After test | 97.6 | 98.0 | 98.6 | 97.9 | 97.9 | 97.3 | 97.3 | 97.7 | 98.0 |
| | exposure 500 | Difference between before | −1.0 | −0.3 | −0.3 | −0.3 | −0.3 | −1.0 | −1.0 | −0.3 | −0.3 |
| | hours | and after test | | | | | | | | | |
| | Accelerated | After test | 96.6 | 97.5 | 98.1 | 97.4 | 97.4 | 96.3 | 96.3 | 97.2 | 97.5 |
| | exposure 1000 | Difference between before | −2.0 | −0.8 | −0.8 | −0.8 | −0.8 | −2.0 | −2.0 | −0.8 | −0.8 |
| | hours | and after test | | | | | | | | | |

Ex: Excellent,
G: Good,
Ba: Bad

As is clear from Tables 1 and 2, the light reflection plates of the present invention have a light reflectance 0.3% to 0.4% higher than that of the light reflection plates of Comparative Examples, which means the light reflection plates of the present invention have high light reflection performance. For example, when the light reflection plate of the present invention is used in a backlight unit of liquid crystal display apparatuses, light that enters a light-guiding plate is guided to the outside on the front surface side of the light-guiding plate, that is, on the liquid crystal panel side after the light is repeatedly reflected between the front and back surfaces of the light-guiding plate and the light reflection plate. In reality, the reflection of the light between the front and back surfaces of the light-guiding plate and the light reflection plate repeatedly occurs several tens of thousands of times. Therefore, the difference 0.3% to 0.4% in light reflectance between the light reflection plate of the present invention and the light reflection plates of Comparative Examples appears as a considerably large difference in terms of the luminance of a liquid crystal panel because the light reaches the liquid crystal panel after having been repeatedly reflected several tens of thousands of times as described above. Accordingly, by using the light reflection plate of the present invention in a backlight unit, the luminance of liquid crystal display apparatuses can be considerably improved.

### INDUSTRIAL APPLICABILITY

The light reflection plate of the present invention can be used in a backlight unit of liquid crystal display apparatuses such as word processors, personal computers, cellular phones, navigation systems, televisions, and portable televisions; backlight of an illuminating device of a surface-emitting system such as an illumination box; and an illuminating apparatus included in strobe illuminating devices, photocopiers, projection-type displays, facsimile machines, and electronic whiteboards.

### REFERENCE SIGNS LIST

10 light reflection plate

12 recess

13 inner bottom surface of recess

13a through-hole

14 inner peripheral surface

15 connecting portion

20 light diffusion layer

21 light-transmissive particles

30 light-guiding plate

40 light source

50 lamp reflector

60 casing

61 bottom portion of casing

62 surrounding wall portion of casing

62a step portion of casing

70 light source body

71 substrate

C illuminating body

L light-emitting diode

1. A light reflection plate comprising:
100 parts by weight of a polyolefin-based resin; and
20 to 120 parts by weight of a coated titanium oxide obtained by coating a surface of titanium oxide with a coating layer containing aluminum oxide and silicon oxide, the coated titanium oxide being constituted by primary particles having a particle size of 0.10 to 0.39 μm and agglomerated particles which are formed by agglomeration of the primary particles and have a particle size of 0.4 μm or more,
wherein the number of the primary particles, which are not agglomerated, in a cross section in a thickness direction is 150 to 550 /900 μm², and
the number of the agglomerated particles in the cross section in the thickness direction is 10 to 160 /900 μm².

2. The light reflection plate according to claim 1, wherein the polyolefin-based resin contains a polypropylene-based resin.

3. The light reflection plate according to claim 1, wherein the polyolefin-based resin contains homopolypropylene.

4. The light reflection plate according to claim 1, wherein the light reflection plate has a thickness of 0.1 to 1.5 mm.
